(19) United States
(12) Patent Application Publication
(10) Pub. No.: US 2013/0104022 A1
(43) Pub. Date: Apr. 25, 2013

(54) SYSTEMS AND METHODS FOR AUTOMATICALLY FILLING-IN INFORMATION

(71) Applicant: Jonathan Coon, Austin, TX (US)

(72) Inventor: Jonathan Coon, Austin, TX (US)

(21) Appl. No.: 13/657,632

(22) Filed: Oct. 22, 2012

Related U.S. Application Data
(60) Provisional application No. 61/550,403, filed on Oct. 22, 2011.

(51) Int. Cl. G06F 17/24

(52) U.S. Cl. CPC G06F 17/243
USPC 715/226

(57) ABSTRACT

A computer-implemented method for auto-filling information is described. A website is accessed on a device. A plurality of fields on the website are analyzed. A location of the device may be determined. At least one of the plurality of fields is filled-in with user information. At least a portion of the user information is based on the location of the device.

### RELATED APPLICATIONS

This application claims the benefit of U.S. Provisional Application No. 61/550,403, filed on Oct. 22, 2011, and entitled SYSTEMS AND METHODS FOR AUTOMATED CHECKOUT, which application is incorporated herein in its entirety by the above references.

### BACKGROUND

The use of communication devices and communication-related technologies continues to increase at a rapid pace. This increased use of communication devices has influenced the advances made to communication-related technologies. Indeed, communication devices have increasingly become an integral part of the business world and the activities of individual consumers. Communication devices may be used to carry out several business, industry, and academic endeavors. The wide-spread use of these devices has been accelerated by the increased use of computer networks, including the Internet.

Users of communication technologies continue to demand an increase in the efficiency of these technologies. Improving the efficiency of communication technologies is always desirable to anyone who uses and relies on the communication devices.

Communication devices may be mobile. Users of mobile devices may communicate with others via data and voice messages. For example, short message service (SMS) messages may be transmitted/received between mobile communication devices. Further, users of these devices may communication with each other via telephone calls using these mobile communication devices.

Increasingly more and more activities may be performed using mobile devices. In many cases, these devices have many if not all of the features of traditional desktop computers and/or servers. However, one of the challenges associated with mobile devices is the ability to quickly and efficiently input information. Many devices rely on miniaturized keyboards and/or touch screen based software keyboards. In many situations, users may be limited to thumb typing or find and peck typing on these types of devices. Often this makes the input of information into a device difficult and inefficient.

### SUMMARY

According to at least one embodiment, a computer-implemented method for completing editable fields is described. A website is accessed on a device. A plurality of fields on the website are analyzed. A location of the device is determined. At least on of the plurality of fields is filled-in with user information. At least a portion of the user information is based on the location of the device.

In one embodiment, the plurality of fields may correspond to an online checkout. In some cases, an automated checkout may be performed using the at least one filled-in field. The user information may include credit card information, billing address information, delivery address information, and/or pickup address information.

In some cases, analyzing the plurality of fields may include identifying each of the plurality of fields, determining a type of information for each of the identified plurality of fields, and determining a category of information for each of the identified plurality of fields. In one example, the user information may be matched to each of the plurality of fields based on the determined category of each of the plurality of fields. In another example, the user information may be matched to each of the plurality of fields based on the determined type of each of the plurality of fields.

In one embodiment, the determined type of information may include credit card information, billing address information, delivery address information, and/or pickup address information. In some configurations, at least a portion of the user information may be stored in a database. For example, a database on the device or a database in the cloud.

A computing device configured to auto-fill information is also described. The computing device may include a processor and computer executable instructions being stored on the memory, wherein the memory is in electronic communication with the processor. The instructions may be executable by a processor to: access a website on a device, analyze a plurality of fields on the website, determine a location of the device, and fill-in at least one of the plurality of fields with user information. At least a portion of the user information is based on the location of the device.

A computer-program product for auto-filling information is also described. The computer-program product includes a non-transitory computer-readable medium having instructions thereon, the instructions being executable by a processor to access a website on a device, analyze a plurality of fields on the website, determine a location of the device, and fill-in at least one of the plurality of fields with user information. At least a portion of the user information is based on the location of the device.

A computer-implemented method for securing auto-fill information is additionally described. An auto-fill mechanism is detected. The auto-fill mechanism is disabled. A security condition is detected. A determination is made as to whether the security condition has been satisfied. Upon determining that the security position has been satisfied, the auto-fill mechanism is enabled. In one example, the security condition may include a logged in state with a secure service. In another example, the security condition may include obtaining a transaction authorization. In some configurations, the transaction authorization may be obtained using an asynchronous transaction authorization system.

A computer-implemented method for reorganizing a plurality of fields is additionally described. A plurality of fields are identified. An order of the plurality of fields may be determined. A first field may be ordered before a second field. A category of information may be determined for each of the plurality of fields. The first field may have a first category of information and the second field may have a second category of information. The second category of information may provide information about the first category of information. At least the first field and the second field may be reordered so that the second field is ordered before the first field.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of an automatic fill-in module;

FIG. 3 is a block diagram illustrating one example of a field detection module;

FIG. 4 is a block diagram illustrating one example of a policy enforcement module;

FIG. 5 is a block diagram illustrating one example of a security module;

FIGS. 6 and 7 illustrate exemplary asynchronous mobile authorization systems incorporating the asynchronous transaction authorization system for asynchronous mobile authorization;

FIG. 8 is an exemplary cellular communication system configured to send and receive SMS and MMS messages via the carrier network in order to facilitate the present exemplary system and method;

FIG. 9 illustrates an exemplary proprietary mobile data and communication system, according to one exemplary embodiment;

FIG. 10 illustrates an exemplary process for pre-authorizing a transaction that exceeds a predetermined threshold using the ATA system, according to one exemplary embodiment;

FIG. 11 illustrates an exemplary ATA process, according to one embodiment;

FIG. 12 illustrates an exemplary ATA process, according to one exemplary embodiment;

FIG. 13 illustrates an exemplary ATA process;

FIG. 14 is a flow diagram illustrating an example of a method for automatically filling-in data entry fields;

FIG. 15 is a flow diagram illustrating an example of a method for automatically filling-in data entry fields;

FIG. 16 is a flow diagram illustrating an example of a method for automatically filling-in data entry fields; and

FIG. 17 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

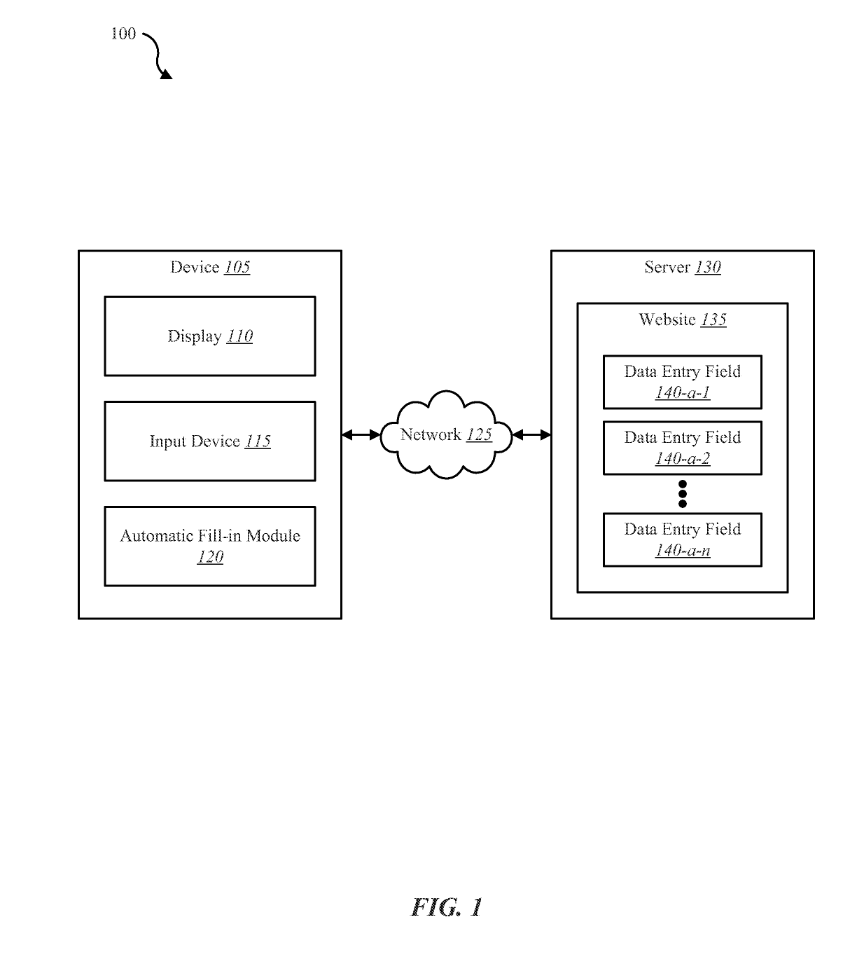

FIG. 1 is a block diagram illustrating one embodiment of an environment 100 in which the present systems and methods may be implemented. In one example, a device 105 may communicate with the server 130 through a network 125. For example, the device 105 may communicate with the server 130 to access a website 135 that is hosted by the server 130. For instance, the server 130 may be a web server that hosts one or more websites 135. In one example, the device 105 may access the website 135 via a web browser. Additionally or alternatively, the device 105 may include one or more applications that may access information that corresponds to the website 135. Examples of devices 105 include computers, tablets, mobile phones, mobile devices, electronic devices etc. Examples of networks 125 include one or more wired networks (e.g., cable, fiber, Ethernet, etc.) and/or one or more wireless networks (e.g., Wi-Fi, cellular, satellite, etc.). In one example, the network 125 may be the Internet.

In some configurations, the device 105 may include a display 110 and an input device 115. In one embodiment, the display 110 may display visual information that corresponds to one or more programs and/or processes running on the device 105. For example, the display 110 may display one or more webpages of the website 135 (that has been rendered by a web browser, for example). In another example, the display 110 may display an application that interfaces with one or more components of a website 135. In one example, at least a portion of the accessed website 135 may be displayed on the display 110 of the device 105.

In one embodiment, the input device 115 may allow a user to interact with one or more programs and/or processes running on the device 105. For example, the input device 115 may enable a user to interact with a website 135 that is being accessed and/or displayed by the device 105. For instance, the input device 115 may allow a user to provide information to a website 135. Examples of input devices 115 include keyboards (e.g., physical keyboards, software keyboards, etc.), touch screens, stylus, mouse, trackpad, etc. In some cases, the input device 115 and the display 110 may be separate components (a QWERTY keyboard separate from a display, for example) and in other cases, the input device 115 and the display 110 may be a single component (a touch screen, for example). In one example, a user may interact with the device 105 by inputting commands through the input device 115 and may receive information from the device through the display 110. Examples of the input device 115 include a keyboard, a touch keyboard, gesture input, stylus input, physical hard keyboard, etc.

In some cases, the website 135 may include a plurality of data entry fields 140. For example, the website 135 may include a first data entry field 140-a-1, a second data entry field 140-a-2, and an nth data entry field 140-a-N. The plurality of data entry fields 140 may correspond to a variety of information. For example, the plurality of data entry fields 140 may correspond to a delivery address, a billing address, and/or credit card information, etc. For example, a first data entry field 140-a-1 may correspond to a credit card number, a second data entry field 140-a-2 may correspond to an expiration month for the credit card, a third data entry field 140-a-3 may correspond to an expiration year for the credit card, and a fourth data entry field 140-a-4 may correspond to a card verification code (CVC) for the credit card. Although the above example is for credit cards, the above example may similarly apply to debit cards, gift cards, coupons, vouchers, checks, etc. In another example, the first data entry field 140-a-1 may correspond to a number and street address, a second data entry field 140-a-2 may correspond to a city, a third data entry field 140-a-3 may correspond to a state, and a fourth data entry field 140-a-4 may correspond to a zip code.

For instance, the website 135 may be a pizza delivery website that allows a user to order a pizza online. In this example, the pizza deliver website may allow a user to select the number and types of pizzas that they would like, the deliver address that the user would like the pizza delivered to, and the credit card number and billing information for the credit card being used. In one embodiment, the pizza delivery website may include a plurality of data entry fields for each of these types of information. In some cases, the data entry fields 140 for these various types of information may span across multiple webpages within the website 135. In one example, a user may access this pizza delivery website 135 on the device 105. At least a portion of the website 135 may be displayed on the display 110 and the user may use the input device 115 to enter the requested information into the data entry fields 140 of the website 135. In some cases, it may be difficult and/or time consuming to enter in all of this information. For example, when the input device 115 is a touch screen and/or miniaturized keyboard (as is often the case on a cell phone or tablet device), it may be difficult to enter some or all of this requested information (with a user's thumbs, for example).

In some configurations, the systems and methods described herein may allow for at least one of automatically filling in one or more requested data entry fields, automatically filling in location information based on the detected location of the device 105, allowing for automating the checkout process, reducing the information that a user must enter, and providing security policies for enabling/disabling each of the above noted features.

In one embodiment, the device 105 may include an automatic fill-in module 120. In one example, the automatic fill-in module 120 may allow one or more of the plurality of data entry fields 140 to be filled in automatically. As will be described below, the automatic fill-in module may be used to automatically provide an address based on location information, automatically reorganize a plurality of data entry fields 140 to more efficiently allow for the input of information, and/or require certain security parameters to be satisfied before automatically filling-in one or more data entry fields 140 within a website 135 and/or initiating an automated checkout.

For example, continuing the example above, the automatic fill-in module 120 may automatically fill-in the credit card information and billing address based on stored information. In this example, the automatic fill-in module 120 may use the location of the device 105 to determine the delivery address. In some configurations, the automatic fill-in module 120 may fill-in each of the data entry fields 140. In some cases, the automatic fill-in module 120 may automate a checkout process by filling in each of the data entry fields 140 (across multiple webpages, if necessary) and submitting the order. In one example, the automatic fill-in module 120 may confirm the information that is being used in an automated checkout prior to performing the automated checkout. The automatic fill-in module 120 is discussed in greater detail below.

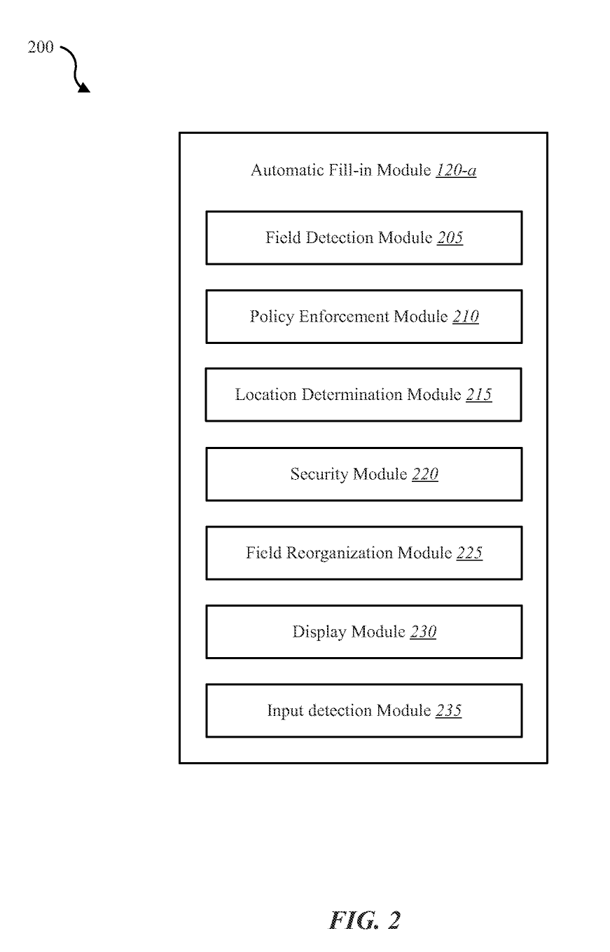

FIG. 2 is a block diagram 200 illustrating one example of an automatic fill-in module 120-a. The automatic fill-in module 120-a may be one example of the automatic fill-in module 120 illustrated in FIG. 1. In some configurations, the automatic fill-in module 120-a may include a field detection module 205, a policy enforcement module 210, a location determination module 215, a security module 220, a field reorganization module 225, a display module 230, and/or an input detection module 235.

In one embodiment, the field detection module 205 may detect the presence of one or more data entry fields 140 within a website 135. For example, the field detection module 205 may scan a website 135 for one or more data entry fields 140. For example, the field detection module 205 may detect each of the data entry fields 140 on a single webpage and/or each of the data entry fields 140 that are spread across multiple webpages of a website 135. For example, the field detection module 205 may detect the data entry fields 140 corresponding to the delivery address on a first webpage of the checkout process and the data entry fields corresponding to the credit card information and the billing address information on a second and/or third webpage of the website 135. The field detection module 205 will be discussed in greater detail below.

In one embodiment, the policy enforcement module 210 may enforce one or more policies that governs the operation of the automatic fill-in module 120-a. For example, the policy enforcement module 210 may set policies as to what information should be auto-filled into one or more data entry fields 140, how the information should be received, and what security requirements should be satisfied before the automatic fill-in abilities are enabled. Additionally, the policies may require that one or more data entry fields 140 be presented to the user in a different order to better facilitate data entry. The policy enforcement module 210 will be discussed in further detail below.

In one embodiment, the location determination module 215 may determine the location of the device 105. For example, the location determination module 215 may determine the location of the device 105 by using a global positioning system (GPS). Additionally or alternatively, the location determination module 215 may determine the location of the device 105 by using one or more of a variety of other positioning mechanisms (e.g., Wi-Fi, Internet Protocol (IP) address, cellular positioning, etc.).

In one embodiment, the security module 220 may enforce one or more security parameters before allowing the automatic fill-in module 120-a to automatically fill-in information and/or perform an automated checkout procedure. In one example, the security module 220 may require that the website 135 be hosted within an authorized secure website (e.g., veribuy.com) before enabling an automatic fill-in mechanism. In another example, the security module 220 may require that a transaction be authorized (e.g., via an asynchronous transaction authorization system) before enabling an automatic fill-in mechanism. The security module 220 will be discussed in further detail below.

In one embodiment, the field reorganization module 225 may reorganize one or more data entry fields 140 of the website 135. In one example, the field reorganization module 225 may disable certain data entry fields 140 until other data entry fields 140 have been filled-in. In anther example, the field reorganization module 225 may alter the way that the website 135 is rendered to alter the order that the data entry fields are presented to the user. In yet another example, the field reorganization module 225 may request the information for the various data entry fields 140 in a preferred order in a separate form (that is presented to the user instead of the website 135 or a portion thereof, for example) and then pass the resulting information to the appropriate data entry fields in the website 135.

In one example, reorganizing the way that address information is requested may reduce the amount of information that a user must input. Often, addresses are formatted with very specific number and street address information appearing first and more general city, state, and zip code information being appearing last. For example, typical data entry fields 140 for addresses request that the number and street address be input in a first data entry field 140-a-1 followed by the city in a second data entry field 140-a-2, the state in a third data entry field 140-a-3, and a zip code in a fourth data entry field 140-a-4. However, efficiencies may be realized by requesting more general information first and filling-in additional information (more specific information and/or more general information) based on the collected more general information. For example, much or all of the address information may be filled-in based on the zip code. For example, the zip code may indicate the city and the state of the address. Additionally (if user profiles indicate certain profiles for different locations, for example), then the zip code may even indicate the specific number and street address of a corresponding user profile (and/or a list of possible profiles that correspond to that location, for example).

In one example, the field reorganization module 225 may reorganize the way that the data entry fields 140 are presented so that information that is put in to one data entry field 140 may be used to help fill-in information that is used in other data entry fields 140. For instance, the data entry field 140 corresponding to the zip code may be reorganized to be presented first to the user so that the user may put this information before entering the data entry fields corresponding to the street and number address. This way, the reorganization of data entry fields 140 may allow for the plurality of data entry fields 140 to be filled in with less user input by the user.

In one embodiment, the display module 230 may use the display 110 to allow the user to interact with the automatic fill-in module 120-a. For example, in the case that a zip code corresponds to more than one possible users for a particular zip code and/or determined location, the display module 230 may use the display 110 to display a list of possible street and number addresses that correspond to the various profiles. In this way, the user may select the desired address from the list rather than inputting the information for each of the data entry fields 140. In another embodiment, the display module 230 may use the display 110 to display a reordered set of data entry fields 140 (that fills-in information as soon as the proper information may be determined, for example). Additionally or alternatively, the display module 230 may indicate a summary of the information that was filled-into one or more data entry fields 140 (manually or automatically). In yet another example, the display module 230 may indicate the information that is being used for an automated checkout procedure and with an option to automatically checkout with the specified information.

In one embodiment, the input detection module 235 may detect input by the input device 115. For example, the input detection module 235 may detect inputs by the input device 115 to allow a user to interact with the automatic fill-in module 120-a. In one example, the input detection module 235 may detect any inputs by a user and may provide this input to the automatic fill-in module 120-a and/or any of the modules within the automatic fill-in module 120-a. For instance, the input detection module 235 may detect any inputs and/or commands received in response to notifications and/or visual information provided by the display 110 (from the display module 230, for example).

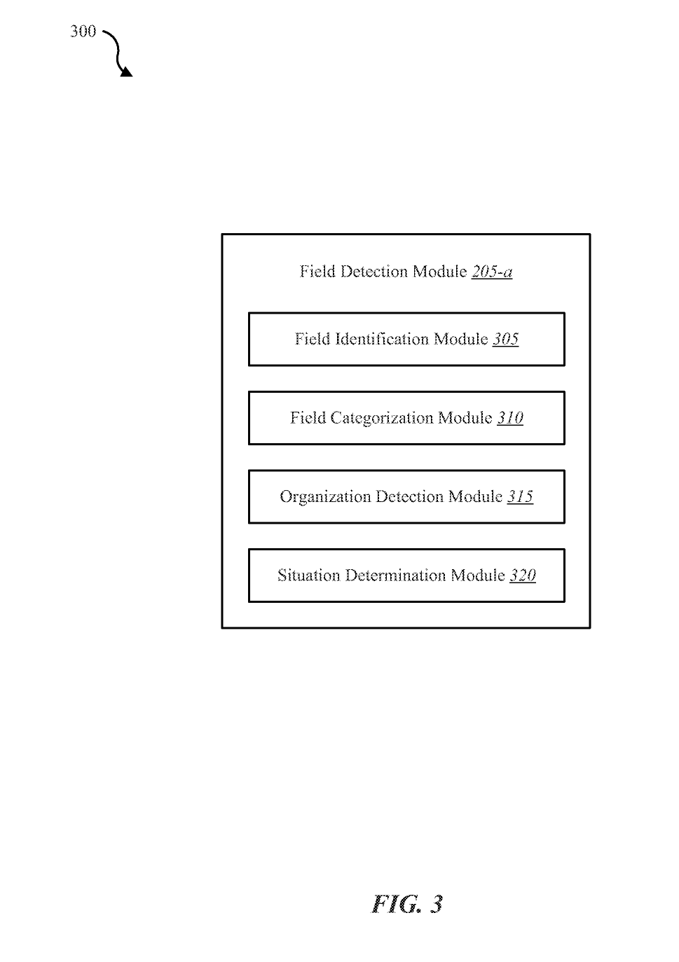

FIG. 3 is a block diagram 300 illustrating one example of a field detection module 205-a. The field detection module 205-a may be one example of the field detection module 205 illustrated in FIG. 2. In some configurations, the field detection module 205-a may include a field identification module 305, a field categorization module 310, an organization detection module 315, and/or a situation determination module 320.

In one embodiment, the field identification module 305 may scan a website 135 and may identify each of the plurality of data entry fields 140 included in the website 135. In one embodiment, the categorization module 310 may categorize each of the identified data entry fields 140. For example, the field categorization module 310 may categorize a data entry field 140 that receives a zip code as a zip code data entry field 140. Similarly, the field categorization module 310 may categorize a data entry field 140 that receives a credit card number as a credit card number data entry field 140, and so forth.

In one embodiment, the organization detection module 315 may detect the organization of the categories of the data entry fields 140. For example, the organization detection module 315 may detect how the various categorized data entry fields 140 are organized and/or grouped together. For instance, the organization detection module 315 may determine that a first zip code data entry field 140 corresponds to a delivery address and should be grouped with the other data entry fields corresponding to the delivery address and that a second data entry field 140 corresponds to a billing address and should be grouped with the other data entry fields corresponding to the billing address. In some cases, the organization detection module 315 may determine the order in which the various categories of data entry fields 140 are presented in the website 135. In some cases, the organization detection module 315 may detect how the various categories of data entry fields are organized across different webpages within a website 135.

In one embodiment, the situation determination module 320 may analyze the context of the website 135 and/or the categories and organization of one or more data entry fields 140 to determine the situation (need dynamic location, or static location, for example) of data entry fields 140. For instance, the situation determination module 320 may determine if the data entry fields correspond to a very short turnaround delivery service where the location of the device would be the desired location for the delivery service. For instance (in the case of ordering pizza, flowers, or take-out food, for example), the situation determination module 320 may determine that the situation would require using the actual location of the device 105 rather than a (predetermined, for example) home or office location. In these situations, it may be beneficial to automatically fill-in the delivery address with an address based on the detected location of the device 105 so that the user may take delivery at their current location (at a friends house, for example). In another example (in the case of ordering a package from an online retailer, for example), the situation determination module 320 may determine that the situation would be better suited by a more established address (e.g., home or work) as the delivery address. In these situations, it may be beneficial to automatically fill-in the delivery address with the more established address.

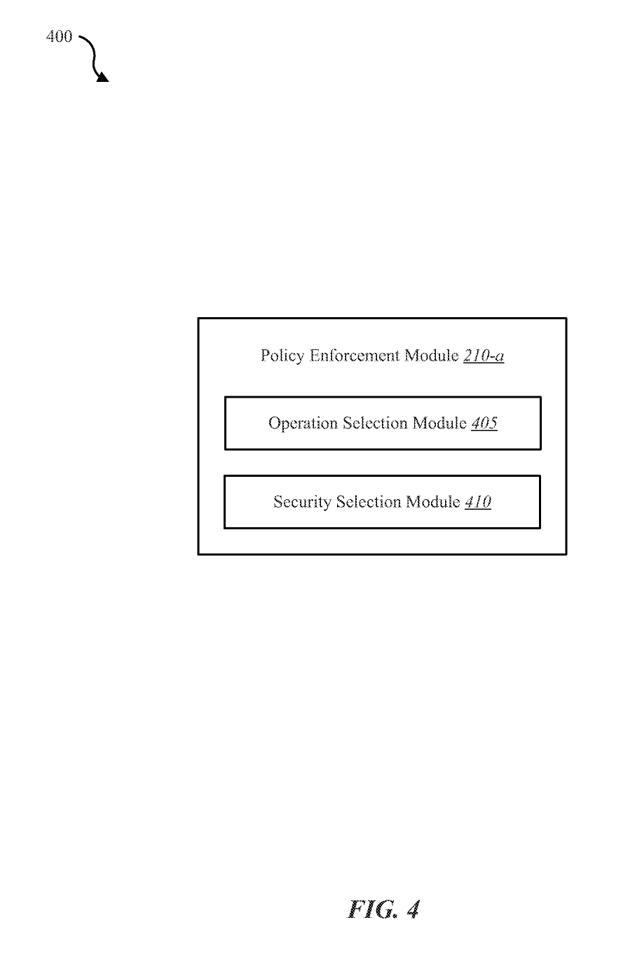

FIG. 4 is a block diagram 400 illustrating one example of a policy enforcement module 210-a. The policy enforcement module 210-a may be one example of the policy enforcement module 210 illustrated in FIG. 2. In some configurations, the policy enforcement module 210-a may include an operation selection module 405 and a security selection module 410.

In one embodiment, the operation selection module 405 may allow for the selection of various operations to be performed by the automatic fill-in module 120-a. For example, the operation selection module 405 may automatically select one or more operations (provided by the location determination module 215 and/or the field reorganization module 225, for example) based on user input and/or a policy (determined based on the situation determined by the situation determination module 320, for example).

In one embodiment, the security selection module 410 may allow for the selection of various security constraints to be used when using the automatic fill-in module 120-a. For example, the security selection module 410 may automatically select one or more security parameters that must be enforced in order to use the automatic fill-in module 120-a. For example, the security selection module 410 may require that the website 315 must be hosted within an authenticated website (e.g., veribuy.com) before the automatic fill-in module 120-a is enabled to fill-in one or more data entry fields 140 and/or enable an automated checkout. In another example, the security selection module 410 may require that a transaction be an authorized transaction before the automatic fill-in module 120-a is enabled to fill in one or more data entry fields 140 and/or enable an automated checkout.

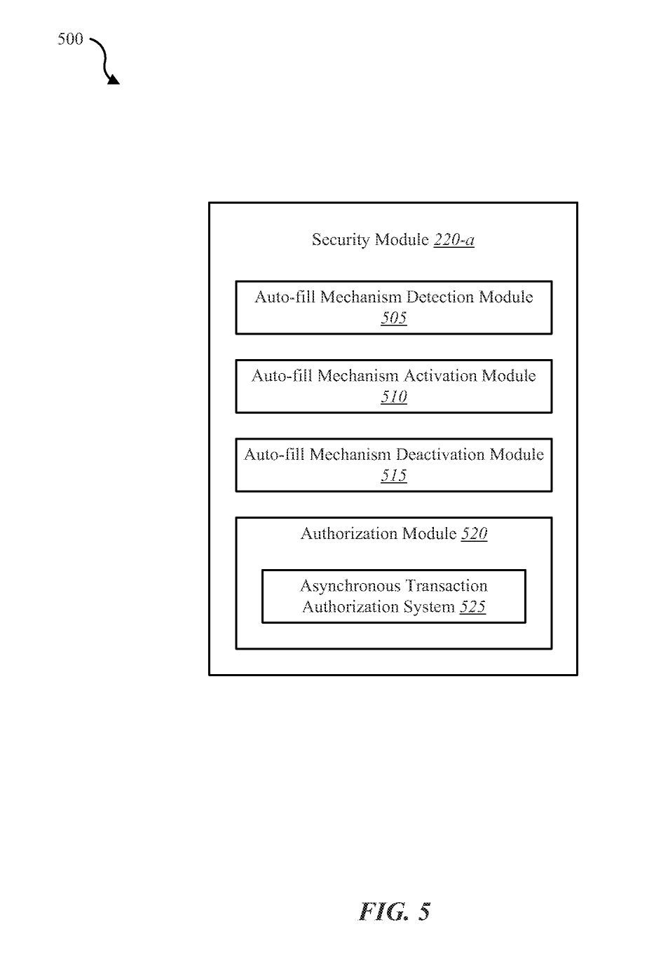

FIG. 5 is a block diagram 500 illustrating one example of a security module 220-a. The security module 220-a may be one example of the security module 220 illustrated in FIG. 2. In some configurations, the security module 220-a may include an auto-fill mechanism detection module 505, an auto-fill mechanism activation module 510, an auto-fill mechanism deactivation module 515, and an authorization module 520.

In one embodiment, the auto-fill mechanism detection module 505 may detect the auto-fill mechanism that is used to auto-fill one or more data entry fields 140. In one example, the auto-fill mechanism may be a cookie that corresponds to the website 135 and holds auto-fill information for one or more data entry fields 140 associated with the website 135. In another example, the auto-fill mechanism may be a browser-based auto-fill mechanism that may auto-fill one or more data entry fields 140 of a website 135.

In one embodiment, the auto-fill mechanism activation module 510 may activate at least one of the detected auto-fill mechanisms. For example, the auto-fill mechanism activation module 510 may change the auto-fill mechanism from a disabled state where it is not able to function to an enabled state where it is enabled to function. In one embodiment, the auto-fill mechanism deactivation module 515 may perform the opposite of the auto-fill mechanism activation module 510. For example, the auto-fill mechanism deactivation module 515 may change the auto-fill mechanism from an enabled state where it is able to function to a disabled state where it is not able to function.

In one embodiment, the authorization module 520 may require authorization for the one or more data entry fields 140 to be automatically filled-in. For example, the authorization module 520 may require that a transaction be authorized before the automatic fill-in module 120-a may automatically fill-in one or more data entry fields 140 and/or perform an automatic checkout procedure. In one example, the authorization module 520 may include an asynchronous transaction authorization 525 for performing transaction authorization.

It may be noted that in one example the automatic fill-in module 120-a may be used to automatically fill in one or more data entry fields 140. In another example, the automatic fill-in module 120-a may be used to perform an automatic checkout procedure. In some cases (when performing an automatic checkout procedure, for example), the security module 220-a may require that the asynchronous transaction authorization system 525 provide authorization before the automatic fill-in module 120-a automatically fills-in any data entry fields 140. The asynchronous transaction authorization system 525 is discussed in greater detail below.

In some cases, the asynchronous transaction authorization system 525 may combat credit card and debit card fraud by leveraging widely adopted wireless communication protocols. Specifically, according to one exemplary embodiment, the asynchronous transaction authorization system 525 may utilizes cellular phones and the short message system (“SMS”) to asynchronously authorize credit and debit card transactions. As used herein, the terms “debit card” and “credit card” shall be used interchangeably to refer to any numerically based instrument that is used for electronic purchase. An example of an asynchronous transaction authorization system 525 is described in U.S. patent application Ser. No. 12/824,974, filed on Jun. 28, 2010, and entitled SYSTEMS AND METHODS FOR ASYNCHRONOUS MOBILE AUTHORIZATION, which application is incorporated by reference, in its entirety.

The asynchronous transaction authorization system 525 may also create further flexibility for credit card use. For instance, a parent may want their child to have a credit card in their wallet at all times in case of an emergency. However, the parent will also likely want to scrutinize any transactions paid for with the card. Similarly, a parent may want their children to learn how to manage an account and to learn the advantages and disadvantages of using credit cards. The present exemplary system and method for asynchronous mobile authorization of credit card purchases enables a parent to be notified of attempted transactions of a designated monetary amount and to authorize or deny the transactions at any location, including locations remote from the point of sale.

Additionally, the asynchronous transaction authorization system 525 may provide one or more account holders the ability to remotely authorize transactions using their cellular phones. This technique not only reduces fraud and the opportunity for fraudulent activity, but can also be used as a tool for fiscal accountability, where card holders that have previously made poor impromptu purchases or have accrued substantial credit card debt are required to obtain the authorization of at least one other individual prior to completing a transaction that meets a designated price threshold. As will be detailed below, the authorization provided by at least one other individual may be asynchronous to the desired transaction in that it may be provided in a time period prior to a desired transaction or immediately after a desired transaction exceeding pre-defined limits has been denied.

The following portion of the present specification details exemplary systems and methods for asynchronous mobile authorization of credit card purchases. The asynchronous transaction authorization system 525 may enable credit card holders, or the account holders of the credit card, to asynchronously authorize credit card purchases in order to protect assets and monitor account behavior, while minimizing cardholder inconvenience, embarrassment, or delay.

While traditional systems for credit card control and/or authorization are dependent on proprietary software being resident on the mobile device and only allow for synchronized authorization at the point of sale, the present exemplary system and method allows account holders to authorize purchases at either the point of sale or at a remote location, thereby adding convenience to the cardholder. Furthermore, the present exemplary system and method provides protection from credit card theft, identity theft, and/or other fraudulent schemes intended to make transactions without the card or account holders' permission. Moreover, the present exemplary system and method allows for multiple account holders to monitor and approve transactions, which is useful in both domestic and commercial settings. Alternate configurations may also include, but are in no way limited to, a tiered authorization structure based on the total purchase price, purchaser, card holder, etc.

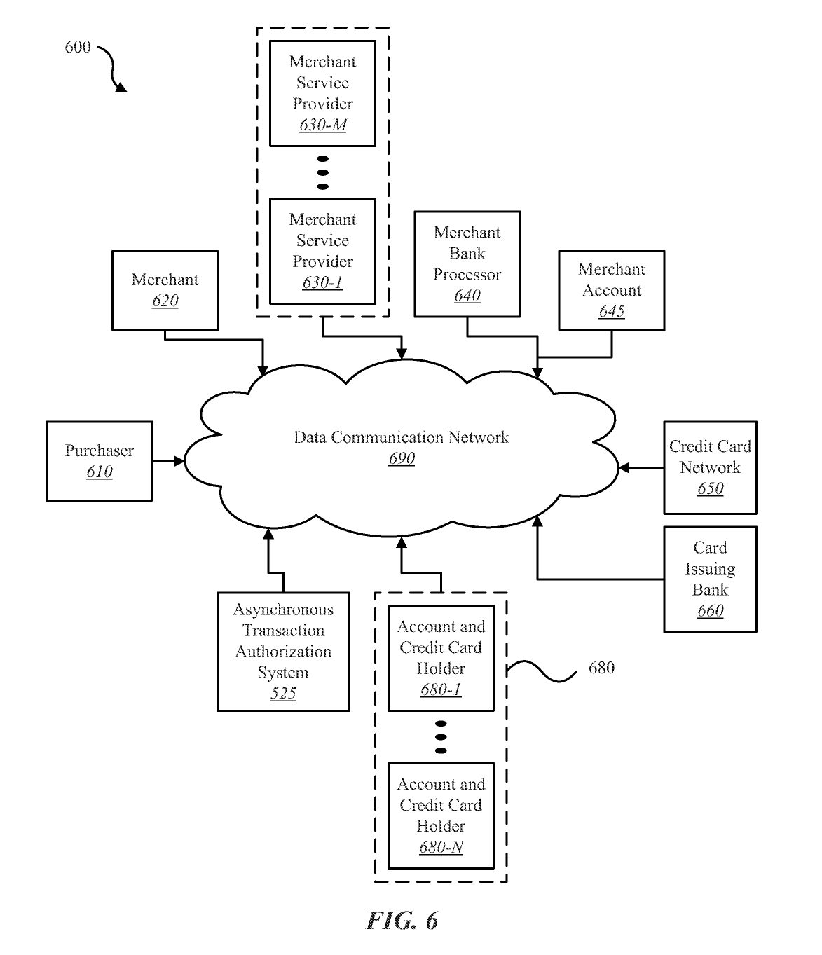

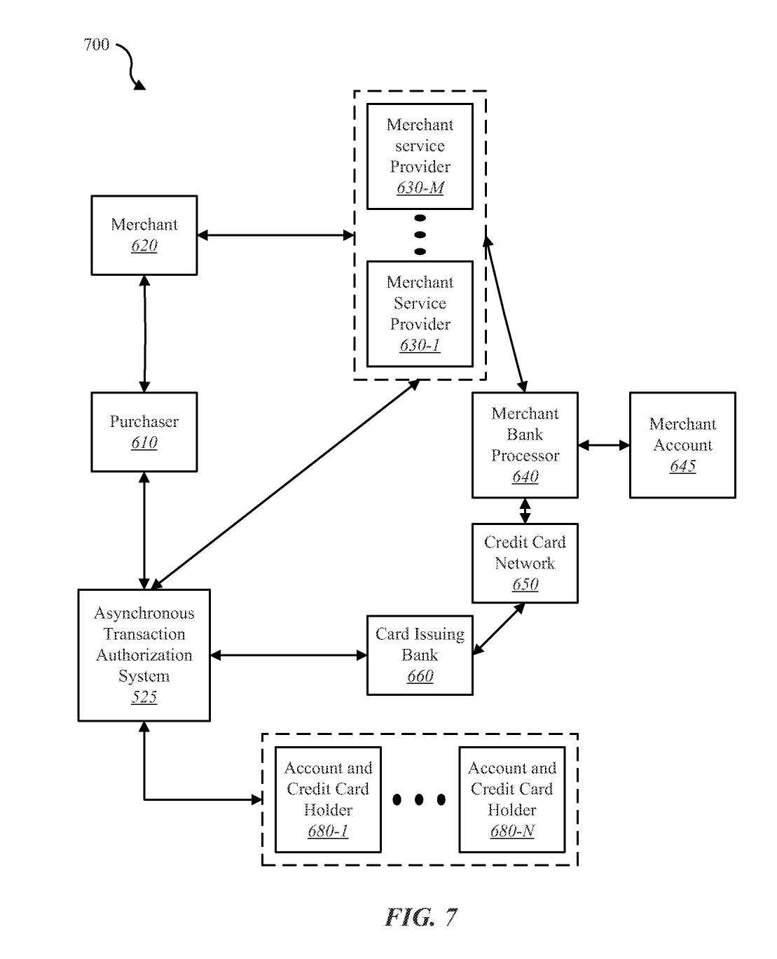

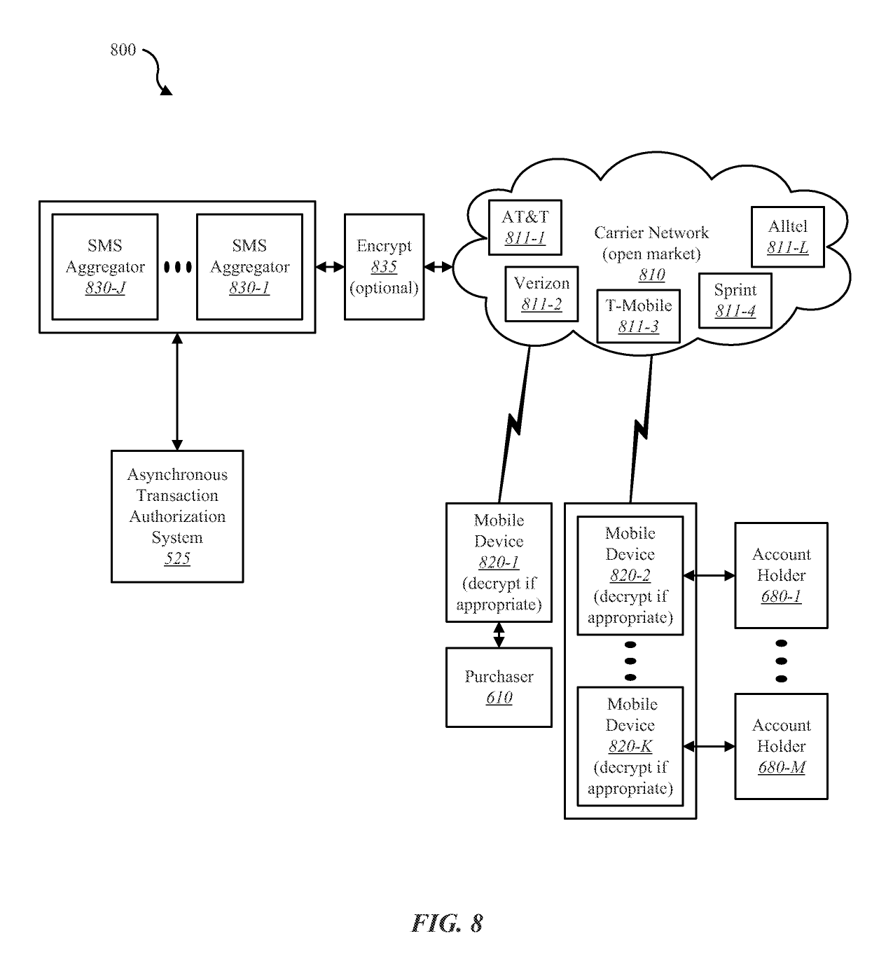

In a domestic setting, as illustrated in FIGS. 6 and 7, a purchaser 610 may be any person that is entrusted with a credit card, including but not limited to a child. According to one example, the guardians and/or account holders 680 of the card entrusted to the purchaser 610 may require that any purchases over a predetermined amount, such as fifty dollars, be authorized by an appropriate number of account holders 680. In one example, when a purchaser 610, which may also be an account holder 680, anticipates making a purchase that exceeds the pre-determined amount, pre-authorization of the desired transaction may be secured using the asynchronous transaction authorization system 525. According to this exemplary embodiment, the purchaser 610 may first obtain the anticipated transaction total, either directly from the merchant 620 or via a separate purchase price accumulator. The purchaser 610 could then, using any number of wireless communication devices including, but in no way limited to an application on a smart phone (ACHD 820; FIG. 8) or text messaging (the SMS 800; FIG. 8) on a non-smartphone, obtain pre-authorization of the desired transaction, using the exemplary systems and methods detailed below.

Furthermore, when obtaining pre-authorization of an anticipated transaction, the account holder(s) 680 or purchaser 610 may enter a desired transaction range for approval, rather than a specific amount. The ability to request approval for a desired transaction range adds the convenience of perhaps not requiring all the desired items to be rung up at a register or, for instance, if an unknown amount will be left for a tip or other situation where the exact transaction amount is unknown. According to this exemplary embodiment, receipt of the transaction request by the exemplary system would cause a notification to be transmitted to the account holder(s) 680. The purchaser 610 may also have the ability to include a note that will be provided to the account holder(s) 680 along with the purchase authorization request, e.g., “buying school supplies at Staples. I need a new printer.” The amount requested, and the note may be presented to the account holder(s) 680 for pre-authorization according to the exemplary systems and methods detailed below.

After the account holder(s) 680 approve the transaction via a responsive SMS text message or other similar feature, notification of approval may be sent via text message to the other account holder(s) 680 and/or the purchaser 610. After a predefined number of account holders 680 have granted approval, the card holder/purchaser 610 may be sent a notification via text message that transaction has been authorized.

Alternatively, according to the present exemplary embodiment, when the merchant 620 is requested to initiate a charge with the entrusted credit card and attempts to complete the transaction that exceeds a predefined threshold, e.g., fifty dollars, and no pre-authorization has been obtained, the transaction is initially declined, and submission results are returned to the merchant 620. According to this exemplary embodiment, the failed transaction exceeding the predefined threshold initiates the transmission of a message to the purchaser 610, such as a text message, notifying the purchaser 610 that authorization of the declined charge is pending. Simultaneously, according to one exemplary embodiment, the account holder(s) 680 also each receive a text message, which may include, but is in no way limited to, the transaction parameters of the recently declined transaction and a query for authorization of a subsequent transaction. The transaction details provided to the account holder(s) 680-1-680-N may include, but are in no way limited to, the merchant's 620 id or name, the charged card number, card holder name, transaction location, and/or transaction price. The text message may also optionally include a request for a keyword that must be in the account holder's response to approve the transaction.

Again, after the account holder(s) 680 approve the transaction via a responsive SMS text message or other similar feature, notification of approval may be sent via text message to the other account holder(s) 680 and/or the purchaser 610. After a predefined number of account holders 680 have granted approval, the card holder/purchaser 610 may be sent a notification via text message that transaction has been approved.

The purchaser 610 can then instruct the merchant 620 to submit the transaction for a second time. The transaction is again requested by the merchant 620 via a credit card terminal or other computing device transmitting transaction parameters to an appropriate receiving system. Once the follow-up transaction request is submitted, the charge will be approved and the sale consummated because the authorization has been given by an appropriate number of account holders 680. Transaction parameters may include any number of descriptive information related to the desired transaction including, but in no way limited to the merchant id and name, amount of desired transaction and the like. Many times merchants will incorporate large computing systems including multiple processors and thus multiple unique merchant identifiers across the multiple processors. Consequently, merchant identifiers may be correlated with the merchant's 620 name for matching authorization with the second transaction request.

Thus, the asynchronous transaction authorization system 525 may be used to track authorized purchases by family members. It may also be used to prevent fraudulent purchases above a designated threshold by those who have stolen either an account holder's 680 card or card information.

These and other uses and benefits of the asynchronous transaction authorization system 525 may become apparent upon consideration of the following examples.

### I. Exemplary System View

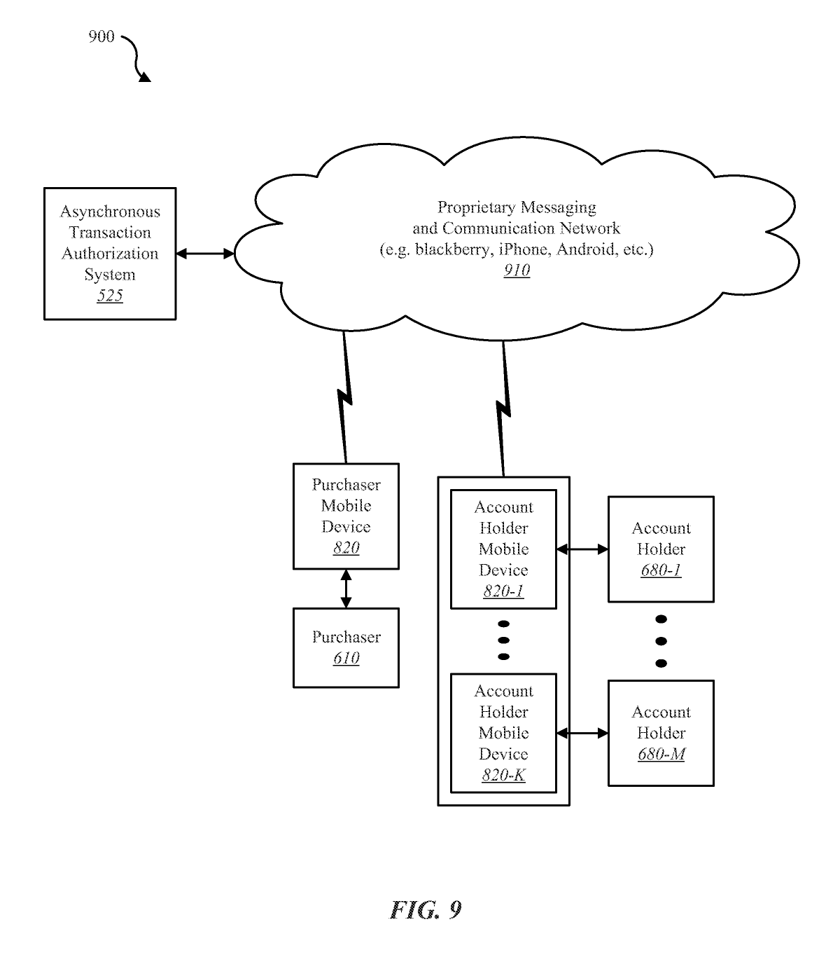

FIG. 6 and FIG. 7 illustrate exemplary asynchronous mobile authorization systems 600 incorporating the asynchronous transaction authorization system 525 for asynchronous mobile authorization. As shown in FIG. 6, the present exemplary system 600 may include a purchaser 610, a merchant 620, a merchant service provider (“MSP”) 630-1-630-M (collectively referred to as “MSPs 630”), a merchant bank processor (“MBP”) 640, a credit card network (“CCN”) 650, a card issuing bank (“CIB”) 660, an asynchronous transaction authorization subsystem (“ATA”) 525, and account or card holder (“ACH”) devices 680-1 through 680-N (collectively “ACHs 680”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The purchaser 610, CCN 650, CIB 660, and ACHs 680 may communicate over any number of technologies including, but in no way limited to, the SMS (800; FIG. 8) and proprietary messaging and data systems (900; FIG. 9).

Through ACH devices 680-1-680-N, e.g., mobile phones, the purchaser 610, and ACHs 680 may be provided with notification of pre-purchase authorization requests, attempted purchases, notification of authorization, notification of each party providing authorization, providing authorization, notification of authorization expiration, and submitted transactions via the ATA 525. The results may be published to any appropriate combination of the purchaser 610, merchant 6120, MSPs 630, MBP 640, CCN 650, CIB 660, ATA 525, ACHs 680, and the ACHDs 820. Elements and functions of the exemplary system 600 of FIG. 6 will now be described in additional detail below.

A. Purchaser 610

The purchaser 610 illustrated in the system of FIG. 6 may be any person attempting to purchase goods or services from a merchant 620 with a credit or debit card. According to one exemplary embodiment, a purchaser 610 includes, but is in no way limited to, an account and credit card holder 680, an authorized agent of an ACH 680, or a fraudulent user of a credit card owned by ACHs 680, and may be initiated via online purchases, in-store purchases, and/or remote caller purchases.

B. Merchant 620

A merchant 620 may be any physical, on-line, phone, or otherwise accessible entity that sells goods or services to the purchaser 610. Popular merchants include, by way of example only, Wal-Mart Stores, Inc., Foot Locker, Inc., and Amazon.com, Inc. According to one exemplary embodiment, a merchant is registered, and makes transactions through, one or more MSPs 630-1-630-M. Prior to accepting credit card transactions, a merchant 620 creates a merchant bank account 645 and then registers the account with one or more merchant MSPs 630-1-630-M. Once established, the merchant 620 can submit a credit card transaction to the MSP 630-1-630-M on behalf of a customer via secure Web site connection, retail store, MOTO center, or wireless device.

A merchant 620 may include or be associated with one or more networks suitable for carrying communications between the merchant 620, and the MSP 630-1-630-M. For example, the merchant 620 may be communicatively coupled to the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant 620 and the MSP 630--630-M.

C. Merchant Service Providers (“MSP”) 630-1-630-M

An MSP 630-1-630-M provides an interface for real-time credit card processing to a merchant 620. Examples of some popular MSPs 630-1-630-M include, by way of example only, Authorize.Net, Paypal, and Beanstream Internet Commerce Corp. Many banks that provide merchant accounts also operate as merchant service providers. An MSP 630-1-630-M receives secure transaction information from a merchant 620 and passes it via a secure connection to the merchant bank processor 640. The MSP 630-1-630-M may be communicatively coupled to one or more networks suitable for carrying communications between the merchant 620, and the MBP 640. For example, the MSP 630 may be communicatively coupled to any network including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant 620 and the MBP 640.

D. Merchant Bank's Processor (“MBP”) 640

As illustrated in FIG. 6, the Merchant Bank's Processor 640 is associated with a bank and provides access to a merchant account 645. Popular MBPs 640 include, by way of example only, Wells Fargo, N.A., Citigroup, Inc., and many other companies which may provide an interface for real-time credit card processing. Many banks that provide merchant accounts are also MBPs 640. The MBP 640 receives a transaction request and submits the transaction to the CCN 650 for authorization and processing. The MBP 640 may be communicatively coupled to one or more networks suitable for carrying communications between the MSP 630, and the CCN 650. For example, the MBP 640 may be communicatively coupled to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the MSP 630 and the CCN 650.

E. Merchant Bank Account 645

The popular merchant banks detailed above, including Wells Fargo, N.A., Citigroup, Inc., and many other companies, offer merchant bank accounts 645 that provide similar features and services, when compared to personal bank accounts, but also typically enable real-time credit card deposits and withdrawals. A merchant bank account 645 may be established and be configured to be accessed and communicate via one or more networks suitable for carrying communications between it and the MBP 640 including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between it and the MBP 640.

F. Credit Card Network (CCN) 650

As illustrated in FIG. 6, the CCN 650 is a system of financial entities that communicate to manage the processing, clearing, and settlement of credit card transactions. The CCN 650 routes a received transaction to the Customer's CIB 660 for approval and further processing. The system of financial entities that function and/or operate in the credit card network 650 may include, but are in no way limited to, Visa, Inc., MasterCard, Inc., and American Express Company. According to one exemplary embodiment, the CCN may be a processor, a server, or any number of dedicated servers that receive credit card transaction requests, identify the card issuing bank associated with the credit card transaction request, and facilitate communication of the credit card transaction request with the card issuing bank 660. Communication between the CCN, and any other entity illustrated in FIG. 6 may be accomplished via one or more networks suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the elements illustrated in FIG. 6.

G. Card Issuing Bank (“CIB”) 660

A CIB 660 is any financial institution, including banks, credit unions, corporations, stores, and the like, which issue the credit card to the ACH 680. Popular CIBs 660 include Wells Fargo, N.A., Citigroup, Inc., JPMorgan Chase & Co., and any other companies that provide credit cards from Visa, Inc., MasterCard, Inc., and American Express Company. Prior to the current system, the CIB 660 was one of the only entities in the transaction process which approved or declined a requested transaction based on the customer's available funds. The CIB 660 would then historically pass the transaction results back to the CCN 650 for further action and/or inaction. In the present exemplary system and method presented, the CIB 660 still approves or declines settlement of credit card transactions, however before final approval, the CIB 660 routes the transaction to the ATA 525 for initial approval.

Similar to the communication details mentioned above, the CIB 660 may be communicatively coupled to one or more networks suitable for carrying communications between the CCN 650 and the ATA 525. For example, the CIB 660 may be communicatively coupled to, but is not limited in its communication connection to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the CCN 650 and the ATA 525.

H. Asynchronous Transaction Authorization Subsystem (“ATA”) 525

According to one exemplary embodiment of the present exemplary asynchronous transaction authorization system 525 illustrated in FIG. 6, an asynchronous transaction authorization subsystem may form an integral component of the asynchronous mobile authorization systems 600. According to the present exemplary system, the ATA 525 may be configured to give approval of a submitted or anticipated transaction that exceeds a predefined threshold only after sufficient ACHs 680 have given approval. The ATA 525 may be included in or reside with, but is in no way constrained to exist within the CCN 650 or the CIB 660, as an inline filter before or after the CCN 650 or the CIB 660. Alternatively, the ATA may exist as a third-party system interfacing with any modules or systems within the credit card authorization process 600 and acting as a clearing house for various transactions based on the thresholds provided.

According to one exemplary embodiment, regardless of the physical location of the ATA, the ATA 525 also may include, but is not limited to one or more servers with software to interface with one or more CIBs 660, one or more SMS aggregators, and electronic storage devices.

Furthermore, as illustrated in FIG. 6, the ATA 525 may communicate with the present exemplary system via a data communication access which may include, but is in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, multimedia messaging service (“MMS”), simple mail transfer protocol (“SMTP”), proprietary communication network via mobile device manufacturer (e.g., iPhone, Blackberry, and Android) proprietary networks for sending and receiving message or instructions 910 and any other communications networks capable of carrying communications between the purchaser 610, CCN 650, CIB 660 and the ACH 680.

I. Account or Authorized Card Holders (“ACH”) 680

As noted previously, an account or authorized card holder is any person that owns or shares ownership of an account and is at least partially responsible for its funds. The ACH 680 may, but is in no way limited to, interface through the SMS 800; FIG. 8, PMMCN 910; FIG. 9, or ACHD 820; FIG. 8. The ACH may, but is in no way limited to communication with any module, subsystem, or class within the system 600.

As noted above, a mobile phone or any computing device including a hand-held computing device may be used to facilitate the access of ACH to the system 600. According to one exemplary embodiment, the ACH 680 interacts with the present system 600 via SMS and/or MMS messaging. FIG. 8 is an exemplary cellular communication system 800 configured to send and receive SMS and MMS messages via the carrier network in order to facilitate the present exemplary system and method. As shown in FIG. 8, the cellular communication system 800 may include a carrier network 810 configured to communicatively couple a purchaser 610, an asynchronous transaction authorization subsystem (“ATA”) 525, account or card holder (“ACH”) devices 680-1 through 680-N) (collectively “ACHs 680”), and mobile device 820-1 through 820-K (collectively “mobile devices 820”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”),File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The cellular communication system 800 will be discussed below.

J. Mobile Device (“ACHD”) 820

According to one exemplary embodiment, the account or authorized card holder device 820 illustrated in FIG. 8 is any mobile computing device which may include, but is not limited to a blackberry, an iPhone, a PDA, a Nintendo DS, or any other mobile device that can send and receive messages over the SMS 800 or propriety messaging network 900. The ACHD 820 may have access to one or more networks suitable for carrying communications between it and the ATA 525. For example, the ACHD 820 may have access to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between it and the ATA 525, the cellular communication system 800, PMMCN 910, or ACH 680.

K. Carrier Network (Open Market) 810

According to the exemplary illustrated embodiment, the present exemplary system may facilitate communication between the purchaser, the ATA 525 and the ACH 680 via a carrier network 810. According to one exemplary embodiment, the carrier network may include, but is in no way limited to, cellular service providers, e.g., AT&T 811-1, Verizon 811-2, T-Mobile 811-3, Sprint 811-4, and Alltel 811-L. The carrier network is a system of cellular providers which are responsible for connection, delivery of data, and service for one or more ACHDs 820. The carrier network 680 may include one or more networks suitable for carrying communications between the ACHDs 820 and the SMS Aggregators 830. For example, the carrier network 810 may access the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ACHDs 820 and the SMS Aggregators 830. Interfacing directly with the carrier network can be both costly and time consuming and therefore, may be abstracted away, through SMS aggregators 830.

L. SMS Aggregator 830

SMS aggregators, such as CellTrust, Inc., Click-a-tell (Pty) Ltd., and MobyQ, LLC provide an interface for computing devices to send and receive messages via the SMS, without direct connection to the carrier network 810. These services typically offer high throughput and statistics that would normally be unavailable through an ACHD 820. An SMS aggregator 830 may communicate via any network suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ATA 525 and the ACHDs 820.

M. Encrypt 835

According to one exemplary embodiment, in order to maintain security of the present exemplary system, the data communications that are transmitted between the various components of the system 600 are encrypted. The encryption and decryption of a message via the SMS, or any message over the carrier network 810 are typically processed independently. The SMS protocol does not typically implement any additional encryption to secure messages between ACHDs 820, SMS aggregators 830, or the ATA 525. Prior work using encryption over SMS or the PMMCN 910 has been documented. It is an industry standard in the financial sector to incorporate encryption mechanisms between mobile/remote access points, therefore the ATA system may, but is not required to do so as well.

FIG. 9 illustrates an exemplary proprietary mobile data and communication system 900, according to one exemplary embodiment. As shown in FIG. 9, the proprietary mobile data and communication system 900 may include a purchaser 910, an asynchronous transaction authorization subsystem (“ATA”) 525, account or card holder (“ACH”) 680-1 through 680-N (collectively “ACHs 680”), device 820-1 through 820-K) (collectively “mobile devices 820”), and a proprietary mobile messaging and communication network 910. In some examples, all persons, modules, and subsystems may communicate using any known communication technologies, devices, media and protocols supportive or remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The proprietary mobile data and communication system 900 will be discussed below.

N. Proprietary Mobile Messaging and Communication Network (“PMMCN”) 910

The proprietary mobile messaging and communications network 910 illustrated in FIG. 9 enables the present exemplary system and method to be conducted over a proprietary network. Specifically, the PMMCN 910 is a system of proprietary messaging and data service providers which are responsible for connection, delivery, and service of one or more ACHDs 820. According to one exemplary embodiment, the PMMCN 910 includes, but is in no way limited to mobile device developers and manufacturers, e.g., Apple (iPhone and iPod Touch), Blackberry, Google (Android), Nintendo (Nintendo DS), etc that enable communication between devices. The use of the PMMNCN 910 allows the ATA to communicate with proprietary applications which run locally on an ACHD 820, but may provide enhanced functionality not normally available through the SMS. Such applications and features may include, but are in no way limited to, bar codes scanners implemented in iPhone and Android applications, as will be described in further detail below.

### II. Exemplary Process Views

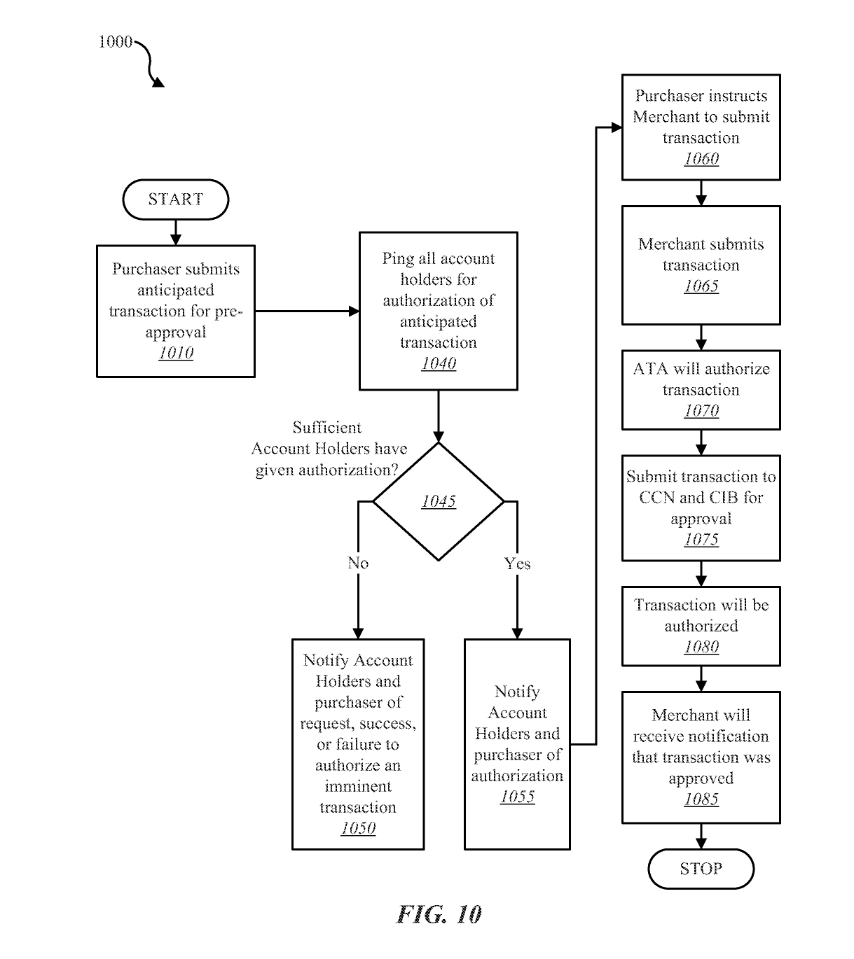

FIG. 10 illustrates an exemplary process for pre-authorizing a transaction that exceeds a predetermined threshold using the ATA system, according to one exemplary embodiment. While FIG. 10 illustrates exemplary steps according to one embodiment, other embodiments may selectively omit, add to, reorder, and/or modify the steps shown in FIG. 10.

As shown in FIG. 10, when a purchaser 610 has identified a desired transaction that exceeds the predetermined threshold amount, the purchaser seeks pre-approval of the desired transaction by submitting the transaction amount to the present exemplary system, step 1010. Optionally the purchaser 610 may submit a range, or a series of prices for which the sum should equal the amount of the anticipated transaction. Once the transaction amount has been received by the ATA 525, the ATA will ping the ACHs 680 for approval, step 1040. As noted above, when the ACHs 680 are contacted for their approval of a proposed transaction, any variation of information may be provided. According to one exemplary embodiment, the transaction authorization request may include any combination of, but is in no way limited to, the transaction amount, merchant information, a description of products being purchased with the transaction, a personalized message, and the like.

In response to the ping sent to the ACHs 1080, the ATA may initiate a timed session wherein approval must be provided by a predetermined number of ACHs 680 or the ATA will decline the pre-authorization.

Regardless of whether or not a session is initiated, the ATA will monitor responses and determine if sufficient ACHs 680 have provided authorization, step 1045. According to this exemplary embodiment, account holders may establish a pre-determined number of ACH authorizations that are needed to authorize a transaction over the pre-determined threshold. Based on the predetermined ACH authorization level, the ATA 525 verifies that sufficient ACH approvals have been received, step 1045. If an insufficient number of ACH approvals have been received by the ATA No, step 545, the ATA notifies the ACHs and the purchaser 610 that the pre-authorization has been declined, step 1050. According to one exemplary embodiment, the ATA 525 may, if insufficient ACH authorizations have been received, remind non-responsive ACHs (180) of the request and responses by other ACHs 680. Upon subsequent ACH responses, step 1045 can repeated, and step 1050 will be repeated until all required ACHs 680 have given approval, declined, or the session times out.

If sufficient ACHs 680 have given authorization (Yes, step 1045), the ACHs and the purchaser are notified of the pre-authorization, step 1055. According to one exemplary embodiment, if the ATA is implemented as part of the CIB 660, the CIB 660 may, in addition to returning information related to the pre-approval of the transaction by the ACHs 680, return information related to whether the anticipated transaction would be approved, denied, or create an overdraft situation based on a lack of funds or other management reason the CIB 660 might provide.

Continuing with FIG. 10, once the purchaser 610 receives notification that the anticipated transaction is authorized, step 1055, the purchaser 610 will instruct the merchant 620 to submit a transaction, step 1060. When the transaction is submitted by the merchant through the MSP, step 1065, the submitted transaction parameters should correspond to the transaction details used for pre-authorization. If the parameters are not substantially the same, or are not submitted within a predefined amount of time from the pre-authorization notification, the transaction will also be declined.

If, however, the parameters of the merchant submitted transaction are sufficiently similar to the originally submitted pre-authorization transaction information (as compared by the ATA), and within a designated period of time, the ATA will authorize the transaction, step 1070, and allow the CCN 650, CIB 660, or any other module or subsystem interfacing with the ATA 525 to verify that all other parameters are in line for approval of the transaction (step 575). While the present exemplary system is described as requiring ATA approval of transaction exceeding the predetermined amount prior to passing the transaction on to the CCN 650 and/or CIB 660, such as if the ATA functioned as a standalone clearinghouse, The ATA 525 may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account, step 1080. Accordingly, the transaction will be approved at the point of sale and the merchant 620 will receive notification that the transaction has been approved and/or completed step 1085. Once completed, the purchaser may obtain the items being purchased.

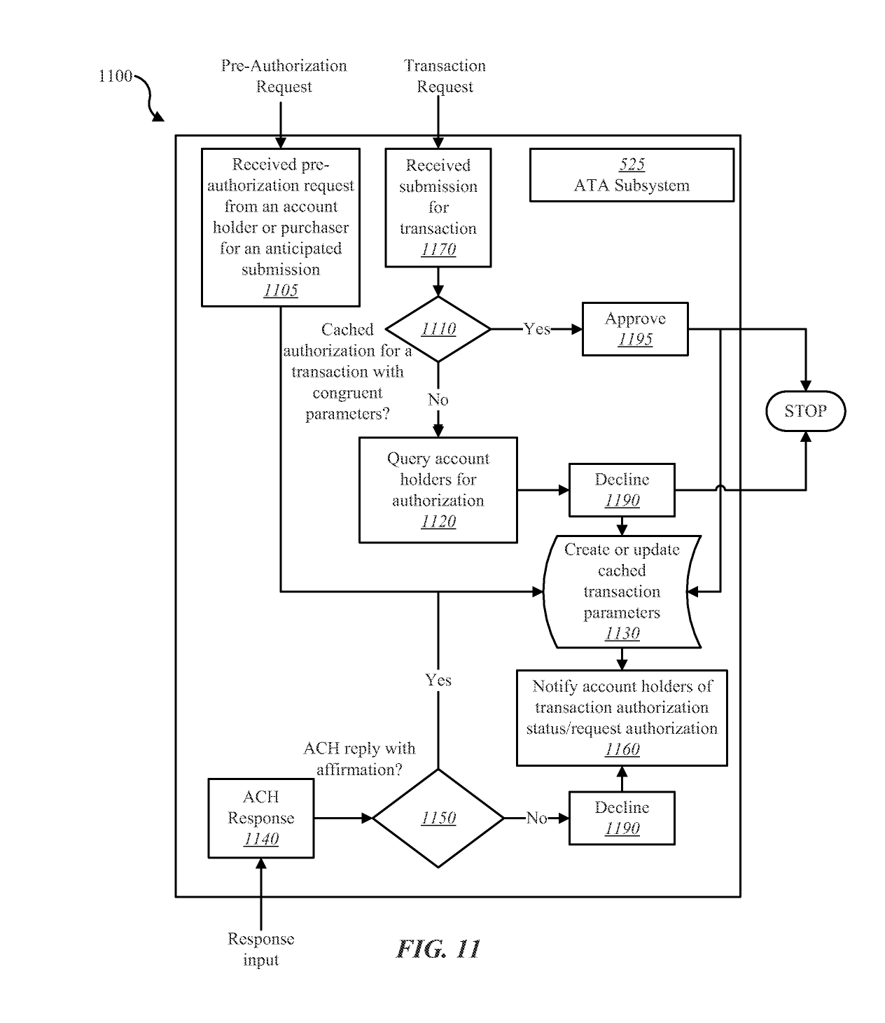

In order to provide further detail of the ATA process, FIG. 11 illustrates an exemplary ATA process, according to one embodiment. While FIG. 11 illustrates exemplary steps according to one exemplary embodiment, other embodiments may omit, add to, reorder, and/or modify any of the steps shown in FIG. 11.

As illustrated in FIG. 11 pre-authorization of any transaction may be given by any number of ACHs 680 to the ATA 525 before any transaction that exceeds a pre-defined threshold is approved, step 1105 (if operating as a standalone clearing house), or through the CCN 650 or the CIB 660 as either an internal system to the CCN 650 or the CIB 660 or as an inline filter before or after the CCN 650 or the CIB 660, step 1110). Pre-authorization is initiated by a pre-authorization request, which may be submitted by a purchaser or an ACH(s) via an ACHD 820, step 1105. When a request for pre-authorization is provided for a transaction that exceeds the pre-determined threshold amount, the ATA 525 will create a new record and/or session with the anticipated transaction parameters, step 1130, which may include, but is in no way limited to, the anticipated price of the transaction or a range within which the anticipated transaction will fall. Next, the ATA 525 will lookup whether or not authorization is needed by other ACHs 680, and either a notification of authorization or a request for authorization will be sent to the ACHs 680, step 1160. In this exemplary embodiment, pre-authorization may be initiated by the ACHs 680 for a known transaction or it may be requested by a purchaser 610.

If, after analyzing the pre-authorization request, the ATA 525 determines that authorization by additional ACHs is needed to meet the threshold authorizations, that authorization is sought, step 1160, and upon receipt of the ACHs 680 authorization, step 1140, the ATA 525 will verify that the response was an affirmative authorization, step 1150. If the response from the other needed ACHs is affirmative (yes), step 1150, the ATA 525 updates the cached record of the anticipated transaction parameters, step 1130. If, however, the response from the remaining ACHs 680 is negative or insufficient to meet the pre-determined number of ACHs approvals, authorization will be declined (No), step 1190. Regardless of the authorization results, the ACHs and/or the purchaser may be notified of the results, step 1160.

When the ATA 525 receives a submission for a transaction by a merchant, step 1170, the ATA 525 will attempt query for an active (meaning not expired due to time delay) record which has been authorized and has congruent parameters with the received submission for transaction, step 1110. If the ATA 525 finds a record corresponding to the received submission for transaction that has been authorized, the submission is said to have been anticipated and authorized, and is approved, step 1195, and the record is updated, step 1130. Thus if another transaction is attempted, for the same price, then the submission will be denied, since a transaction was already approved with the transaction parameters.

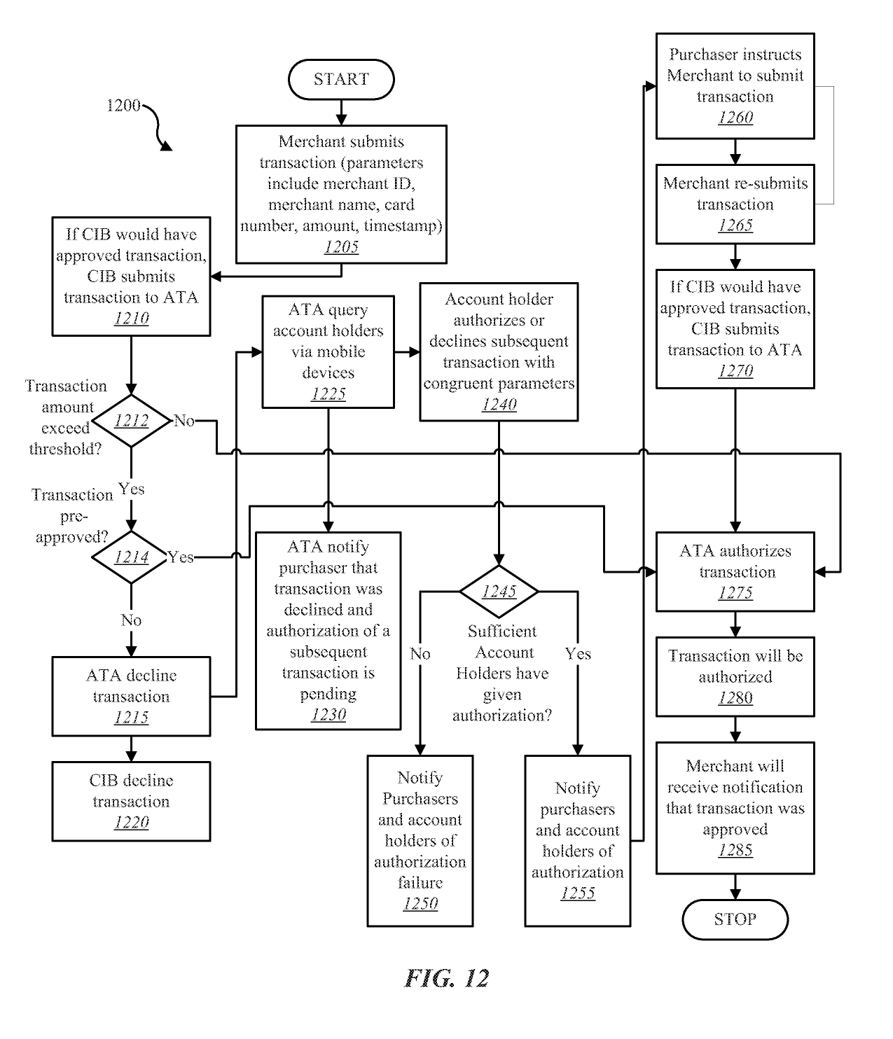

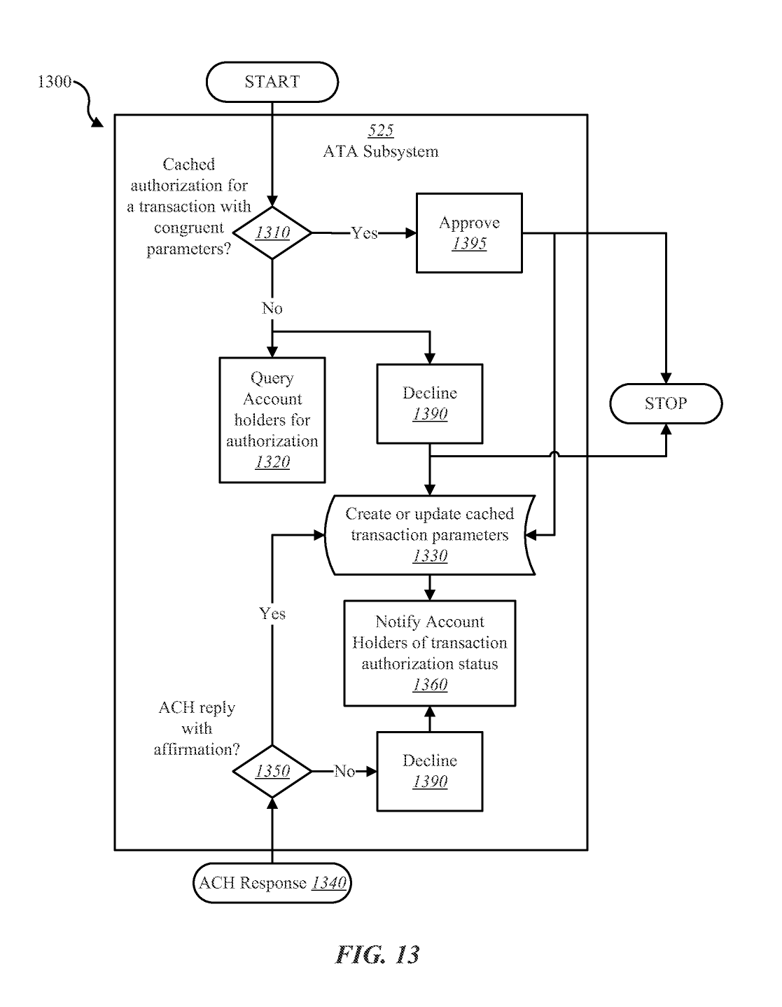

If, however, the ATA 525 receives a submission for a transaction exceeding the pre-defined threshold and finds no corresponding active record of authorization, then the ACHs 680 will be queried for authorization (No), step 1120, and the submission will initially be declined, step 1190. If there is no record of an authorization with parameters matching the submission parameters, then a record will be created with the submitted transaction's parameters, step 1130. Then, the ACHs 680 will be notified of the transaction, step 1160, to take remedial actions in the case of fraudulent activity, or to proceed with providing post transaction approval, as is detailed below with reference to FIGS. 12 and 13.

FIG. 12 illustrates an exemplary ATA process, according to one exemplary embodiment. While FIG. 12 illustrates exemplary steps according to one embodiment, other embodiments may selectively omit, add to, reorder, and/or modify the steps shown in FIG. 12.

As noted above, purchasers may request a transaction, either unintentionally or as an alternative to pre-approval, that exceeds the predetermined threshold and that has not received pre-approval. Consequently, the transaction will be declined and post transaction approval will be sought. As shown in FIG. 12, a merchant 620 initially receives a request to complete a transaction and subsequently submits a transaction for approval by the CCN 650, CIB 660, and ATA 525, step 1205. The parameters in the submission made by the merchant 620 may include, but are in no way limited to the merchant's ID or name, amount of money requested for the purchase, credit card information, and a timestamp. The merchant ID is a number assigned to the merchant by the merchant's MSP 630. However, amongst larger merchants it is common to have several MSP 630 accounts for redundancy and failsafe mechanisms. Each MSP 630 can assign an arbitrary merchant id to each merchant 620. Therefore, since some merchants 620 may submit a transaction for approval using one MSP 630 and then use a different MSP 630 for a subsequent submission, the merchant name, as well as the merchant ID, may be equally important to track. The timestamp of the submission is used to ensure that a subsequent submission is within a predefined amount of time. Subsequent submissions that occur after the predefined time period will not be correlated or associated with each other, and will be treated as a separate purchases. While it is also likely that the ATA 525 may not rely on this timestamp, however, it may be useful for other features including but not limited to testing and data integrity metrics.

Once the transaction is submitted from the merchant 620, the CCN 650, CIB 660, and/or ATA 525 will receive the submission from the merchant 620. In the present example, for ease of explanation, the ATA 525 will be described as residing on the CCN 650 and CIB 660, the ATA 525 may operate within, or as pre- or post-filter, or as a third-party. Furthermore, the ATA 525 is not restricted to any specific module or subsystem, and may be included, or communicated to, by any module or subsystem in the system 600. Therefore, the submission received may be carried to a separate network, or be executed on an existing network or system within any module or subsystem in the authorization system 600.

If the requested transaction does not exceed the predetermined threshold amount, the ATA will allow the transaction to pass through and be acted upon by the CCN 650 and the CIB 660 as processed by traditional systems.

However, if the transaction amount exceeds the predetermined threshold and no pre-approval has been sought, the ATA will be activated and the ATA will decline the first submission for a transaction, step 1215. In conjunction with declining the first transaction, the ATA will also decline the submission for the proposed transactions to the CIB, step 1220. The declined submission may be returned to any module which interfaces with the ATA 525, and may include but is in no way limited to the CCN 650 and the CIB 660. Declining of the first transaction while authorization is sought is significant in that it frees up the point of sale transaction components (such as credit card processing devices, PIN pads, cash registers, and the like) utilized by the merchant. This allows the merchant to continue to transact business while the present exemplary system seeks authorization. In contrast, traditional systems would take the entire bandwidth of the point of sale transaction components until approval/decline is received or the process times out. Traditional charge approval systems time out within seconds—much too quickly to allow for synchronous cardholder approval of a charge.

Additionally, the ATA 525 will query the account holder(s) via

ACHDs 820. Prior to sending the query, the ATA 525 will store and maintain a record of the declined transaction submission. The ATA 525 may, but is not limited to, recording all the parameters discussed above in, step 1205 related to the declined submission. The record may also include a link to all associated ACHs 680 on the credit card. Furthermore, the record may also record the authorization or denial of each ACH 680. The record may be, but is not limited to, storage on an electronic storage device built to store and archive large segments of data, or an electronic storage device specifically built to create, recall, and update data quickly. Electronic storage devices which are specifically built for speed often provide a limited ability in the amount of data stored, however a caching mechanism using both types of devices may be useful for record keeping, and efficient processing of millions of submissions per minute world wide. The ATA 525 will send the query via the SMS 800, carrier network 810, or PMMDN 910 to the ACHs 680 for response, step 1225). The query sent to the ACH 680 via the ACHD 820 may be transmitted via the cellular communication system 800, the proprietary mobile data and communication system 900, or any other communication system. As mentioned previously, the ATA 525 queries the account holders via their mobile devices in order to obtain their authorization for the transaction that exceeded the predetermined threshold value. According to one exemplary embodiment the query received by the account and credit card holder 680 is in the form of an SMS message. Alternatively, the query may include embedded code that allows the ACH 680 to merely select a GUI (graphical user interface) button or other indicator to authorize the transaction.

Along with the query transmitted to the account and credit card holder 680, the ATA 525 may notify the purchaser 610 and/or the merchant that transaction submission was declined due to insufficient funds or another reason, step 1230. Alternatively, the purchaser 610 associated with the card used may receive a message informing them that the transaction was declined only because authorization from ACHs 680 is pending, step 1230. This step provides further card security in the case of an identity or card theft. Specifically, a person that steals a card or card number and then attempts a purchase that exceeds the predetermined threshold will only be notified by the merchant that the transaction did not go through. They will not receive the notice from the ATA 525 that authorization is pending. Consequently, the criminal attempting to misuse the card will likely assume that the theft had been reported and the card deactivated. Furthermore, other modules and subsystems may use the ATA to notify the purchaser 610 or the ACHs 680 of the status of the submitted transactions.

Once the appropriate queries and notices have gone out, the contacted ACH 680 authorizes or declines a subsequent transaction via an ACHD 820, step 1240. This process may, but is in no way limited to the following exemplary protocols. The ACH may respond to notification from step 1225, with an affirmative SMS message containing the word “yes,” or “y,” a predefined keyword, a dynamic keyword provided in the query from step 1225, a dynamic graphical user interface that simulates the clicking of a button, or any other forms of electronic acceptance or denial via the SMS 800, PMMDN 910, or proprietary applications defined prior to the ACH receiving the query, step 1225.

After sending out the queries, the ATA 525 then awaits the responses from the ACHs. As illustrated in FIG. 12, the ATA 525 stores response from the ACH 680 to the query and determines if sufficient ACHs 680 have responded with authorization, step 1245. According to one exemplary embodiment, the certification of an approval from the ACH 680 may be performed by matching an approval message with the ACH's corresponding phone number, by the receipt of a dynamically generated keyword or code that corresponds to the specific ACH and transaction, by the receipt of approval along with a cookie or other tracking kernel that may be associated with the response, and similar technologies. As noted previously, the present exemplary system and method may be configured to authorize a transaction exceeding a predetermined amount if a predetermined number of affirmative responses are received by the ATA. The appropriate amount of responses sufficient for authorization may be set by the user, and may also require authorization from the purchaser to prevent fraudulent transactions.

Regardless of whether the transaction is authorized or declined by the ACHs, a notification may be sent to the purchaser 680, and all other ACHs 680 that a sufficient number of ACH 680 has authorized or declined a subsequent submission of the transaction, step 1250. Again, this notification may, according to one exemplary embodiment, be sent via SMS or MMS. In response to the authorization notice, the purchaser 610 or the ACHs 680 may then take appropriate and immediate action since they are on notice that the credit card is being used, whether fraudulently or without permission. Throughout this process funds remain protected.

When the ATA 525 receives sufficient authorizations (Yes), step 1245, the ATA 525 may send a response to the purchaser 610 and all ACHs 680 that authorization of a subsequent transaction with similar parameters has been given, step 1255.

As the purchaser is now notified that a subsequent transaction is authorized, the purchaser can 610 instruct the merchant 620 to resubmit transaction, step 1260. When the transaction is again submitted by the merchant through the MSP, step 1265, the aforementioned parameters from step 1205 should be the same, with the possible exception of the merchant ID for large merchants. If the parameters are not substantially the same, or are not re-submitted within a predefined amount of time, the subsequent transaction will also be declined.

If, however, the parameters of the subsequently submitted transaction are sufficiently similar to the originally submitted transaction (as compared by the ATA 525), and within a designated period of time, the ATA 525 will authorize the transaction, step 1270, and allow the CCN 650, CIB 660, or any other module or subsystem interfacing with the ATA 525 to verify that all other parameters are in line for approval of the transaction, step 1275. The present exemplary system is described as requiring ATA approval of transaction exceeding the predetermined amount prior to passing the transaction on to the CCN 650 and/or CIB 660. However, as the ATA may be a standalone clearing house application or may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account, step 1280. Accordingly, the transaction will be approved at the point of sale and the merchant 620 will receive notification that the transaction has been approved and/or completed, similar to prior methods, step 1285. Once completed, the purchaser may obtain the items being purchased.

In order to provide further detail of the ATA process, FIG. 13 illustrates an exemplary ATA process. While FIG. 13 illustrates exemplary steps according to one embodiment, other embodiments may omit, add to, reorder, and/or modify any of the steps shown in FIG. 13.

As illustrated in FIG. 13, submission of a transaction by the merchant 620 is given either directly to the ATA 525 (if operating as a standalone clearing house) or through the CCN 650 or the CIB 660 as either an internal system to the CCN 650 or the CIB 660 or as an inline filter before or after the CCN 650 or the CIB 660, step 1310. Authorization of a transaction is requested when a merchant 620 submits a transaction for goods or services to be purchased by the purchaser 610. When a transaction is requested, a query may be performed to identify a prior submission according to the merchant's 620 id and/or name, price of the transaction, time the transaction parameter record was created, and current time minus delta. A delta is defined as a discrete amount of time from when the authorization was given and the time the subsequent submission. If delta is greater than a predefined period, then the record will not be identified as a prior submission. Otherwise, if the record includes authorization from all required ACHs 680, and delta is less than the predefined period, then the process proceeds to approve the transaction, step 1295. If, however, no previous authorization has been provided, the ATA 525 treats the authorization request as a new transaction and declines the transaction, step 1290.

Upon declining a transaction, the ATA 525 queries all ACHs 680 associated with the card used for the transaction, via text message, sent through an SMS aggregator's application programming interface (“API”), step 1320. SMS aggregators may also provide encryption services for further security. The query may, but is not limited to, include a unique keyword which ACHs must respond with to approve a subsequent submission. The query may also include, but is in no way limited to the parameters of the denied transaction, e.g. merchant 620 ID or name, total transaction price, card number, card holder name, date and time of transaction, and location.

The query in step 1320 is stored as a transaction record in ATA's 525 electronic storage device and cache, step 1330. Query parameters, and other parameters not listed may be stored as well.

When a response to the query is received from the ACH, step 1340, via SMS aggregator API, the ATA 525 then determines if the response is an authorization or an indication of a desire to decline, step 1350. If ATA 525 receives authorization (Yes), step 1350, the corresponding transaction record is retrieved. Authorization from ACH is stored in the transaction record and notification of the ACH 680 approval is sent via the SMS aggregator 830 to purchaser 610 and other associated ACHs 680. If sufficient ACHs have granted approval then notification of approval is sent to purchaser 610 and all associated ACHs 680 to the transaction.

Conversely, if sufficient ACH replies are not received (No), step 1350, the transaction is declined, step 1390, and notification of such is sent to the ACHs 680 and purchaser, step 1360. According to one exemplary embodiment, any time a transaction is declined, the declined submission may be routed to CIB 660 or any other source interfacing with the ATA 525.

When a transaction is approved by the ATA 525, step 1395, the transaction is routed to the CIB 660, and the cached record may be deleted or marked as final, to prevent further transactions with similar parameters being approved. Approval may also be routed to any source interfacing with the ATA, e.g., CCN 650.

In addition to the above-mentioned systems and methods, a number of alternative embodiments may be incorporated. According to one alternative embodiment, the present system and method may not be limited to a single transaction. More particularly, the ATA can track the total spending by a purchaser associated with a credit card for a predetermined period of time. According to this exemplary embodiment, the ATA will continue to pass purchases through to the CCN and CIB for normal processing, so long as the predetermined threshold is not exceeded. However, when the predetermined threshold is exceeded for the identified period of time, the ATA will be activated and sufficient approval from the ACH will be required for subsequent authorizations during the designated time periods. It will be understood that, according to this exemplary embodiment, any time period may be designated including, but in no way limited to, a number of hours, days, weeks, months, and/or years.

Additionally, according to one exemplary embodiment, pre-authorization may be obtained. According to this embodiment, a module on a handheld device may include instructions which, when accessed by a processor of the handheld device, enable the processor to receive images of bar-codes, interpret the bar-codes and correlate the bar-codes with a product and price, and calculate the transaction cost of purchasing the one or more items associated with the bar-code(s). The exemplary module may incorporate known bar-code and product correlation systems and methods commercially available, such as utilized in the RedLaser iPhone app by Occipital and other similar products. According to this alternative embodiment, when a purchaser has identified all the products they will be purchasing, the computer readable instructions can cause the processor to submit the anticipated charges to the ATA system 525 as an initial transaction exceeding the predetermined threshold amount so that authorization from sufficient ACHs 680 may be obtained.

Yet another exemplary embodiment of the present system and method may further reduce and/or eliminate the possibility of identify theft and fraud by incorporating security features in addition to the numerous features detailed above. For example, according to one exemplary embodiment, the above-mentioned systems and methods, may include, but are in no way limited to, at least a two part authorization process.

While the present exemplary system and method includes transmitting messages and authorizations wirelessly, it may be possible for a technically savvy criminal to assume an ACH's caller ID or hack into someone's network to assume their identification credentials. However, it is quite technologically difficult to intercept an SMS message directly to your phone, in order to perpetrate a fraud.

According to this exemplary embodiment, the ATA may request additional verification and/or confirmation after the initial pre-purchase authorization and confirmation was given, as detailed above. The confirmation message may include, but is in no ways limited to, the parameters of the anticipated or declined transaction, a note from the purchaser, a time period for which a code will be active, and a specific code that the ACH must copy and paste in a response to the ATA.

Specifically, according to one exemplary embodiment, the customer or ACH may send, via SMS, a request for pre-approval. In response, when the request has been granted, as described in detail above, the ATA sends confirmation including a code. When received, the customer cuts and pastes code into a second confirmation reply and sends the message (including the code) to the ATA. Upon receipt, the ATA confirms that the correct code has been received and sends a subsequent message detailing that x amount will be approved for the next y minutes. In sum, the exemplary system including enhanced fraud protection includes the sending of two SMS messages: one to initiate and provide pre-authorization, and a second to confirm the details sent back to them by the ATA system. Response to the second approval may be in any of the forms mentioned above, including, but in no way limited to, the transmission of a Y or a N, the selection of a GUI interface meant to simulate a physical button, the entry of a code in the response, and the like.

An additional method that may be used independently or in combination with the double authentication method detailed above includes providing a predefined personal identification number (“PIN”) to each ACH. In this exemplary embodiment, the ACH 680 may previously receive or independently set a PIN, such that when an ACH 680 replies to a query for authorization, the ATA 525 will only accept authorization if the PIN associated with the transmitting ACH is included. An ACH 680 may also include the PIN in the original authorization. In order to circumvent this exemplary theft prevention, a thief must have the ACH's card and PIN, while spoofing the ACH's phone number. If the use of a PIN is implemented with the exemplary double authorization method, a thief would need the ACH's card, PIN, and phone to make any fraudulent charges.

Yet another exemplary embodiment, may include, but is in no way limited to, public/private key encryption. This could be implemented using the SMS 800 or PMCN 900. When the bank account is setup to use the ATA 525 a private and public key is generated and placed on the respective devices and systems. Thereafter the query will only be readable by someone using a specific phone, and the response will also only be readable by the ATA.

The preceding exemplary views of the ATA may be implemented as either pre- or post-transaction methods.

In the preceding exemplary views the ATA system includes authorizations by one or more ACHs 680, this may include, but is in no way limited to, situations where there are multiple ACHs and those ACHs are the parents of the purchaser 610, or a company where the ACHs 680 are officers or supervisors within that company and an employee is the purchaser 610. By requiring a certain level of authorization for purchases exceeding a predefined amount, the present exemplary system reinforces fiscal responsibility while providing account security and fraud protection.

Traditional transactional systems and methods have relied solely on possession of the credit card or credit card information to authorize transactions. However, such security measures have been proven to be unreliable, and do not provide the flexibility that families, groups, or companies may enjoy with the exemplary systems described or similar systems. The present exemplary system and method ensures that, despite the theft of a credit card or credit card information, the merchant 620, the ACHs 680, and purchasers 610 are protected from unauthorized charges. Furthermore, this method would not impose an unforeseen or unreasonable burden on merchants 620 or cause embarrassment for the purchaser 610 as they are accustomed to denial of an initial transaction, with the approval of a subsequent submission. Lastly the notifications transmitted to the purchaser 610 and ACHs 680 described in the exemplary system would allow the purchaser 610 to know and update the merchant 620 of the authorization progress of the intended transaction.

Leveraging the security and anti-theft features described above, consumers can be more confident in participating in on-line shopping. Consequently, previously unused or less secure processes can be combined with the asynchronous transaction authorization system to maximize process convenience. For example, auto-fill systems and processes used to be more popular. However, many people still use it. In traditional auto-fill systems, a user will input and save their contact and other personal information—name, address, city, state, zip code, and phone number—billing and shipping. Some users would elect to input their credit card information as well and let the card number, expiration date, CVC code, all auto-fill as well.

However, as identity theft and information mining became more widespread, security experts strongly advised that people not use auto-fill, particularly not for credit card data, because auto-fill provides an additional opportunity for a hacker to obtain the user's information. In particular, auto-fill allows exposure to a user's credit card number.

According to the present exemplary system and method, a user may leverage the present security features to protect from excessive fraudulent credit card charges, making auto-fill features practical.

According to this exemplary system and method, a user, whether using desktop, laptop, mobile, tablet, or other computing device, can first direct their browser to a main website, such as veribuy.com or a website such as perhaps shop.veribuy.com.

The main website may include a URL field for the customer to fill-in—to identify where the user intends to access and/or shop, i.e. a website such as eBay, zappos.com, and the like. The target website field can be enabled to handshake or otherwise be powered by Google or another website to quickly complete the user's typing for her. If the user wanted to shop at crazyeddie.com, she would just enter the URL “crazyeddie.com” into the URL field on the main website (i.e. shop.veribuy.com site).

The main website may enable browsing of the target website, while keeping the user at the main website via any number of methods including, but in no way limited to, the main website framing the target website. Specifically, once loaded, the user is able to browse the intended site—crazyeddie.com—within the main website (i.e. the shop.veribuy.com site). According to one exemplary embodiment, the main website is not a browser, but a website. In this embodiment, nothing looks different about the crazyeddie.com website except that there may be a logo or other indicator on the page informing the user that the main website is monitoring the security of the user's shopping. When the user gets to the checkout page, she can click on or tap the logo and all of her information, including the credit card information, will be filled in for her. No more entering credit card information with her thumbs (or any of the other information). Thus, in one example, the present systems and methods may be used to implement an automated checkout process.

According to one exemplary embodiment, the main website (i.e. shop.veribuy.com site) will have additional intelligence and features when compared to traditional auto-fill features. Specifically, the main website will be customized for the most popular retail websites. If the website has a series of screens required for completing the checkout page, the main website (i.e. shop.veribuy.com site) will initiate a program that will page through the necessary screens and initiate an auto-fill process (i.e. using a string compare or other process/function to approximate requested information) and proceed to the final checkout page for user approval. The user can store any information on the main website to be filled in by the auto-fill process including, but in no way limited to, multiple ship to addresses, phone numbers, etc. The user may select from the different ship to addresses, phone numbers, etc. and have these filled in automatically.

Particularly, according to the present exemplary embodiment, the present exemplary system and method is more than auto-fill, it is auto checkout. On any retail website, once the user decides what she wants to order, they don't have to go through all the thumb typing (if on mobile) to fill everything out, including credit card information.

As mentioned previously, the ability to auto-fill credit card information is made possible by the asynchronous credit card authorization system and method described above. The described auto-fill feature couldn't have been performed previously because users would not be willing to have their credit card information on file. However, with the present exemplary asynchronous authorization system, the user's credit card can never be used without permission, so the concern is eliminated. According to the present system a user's credit card number is less valuable than the user name and address information.

According to one exemplary embodiment, the main website is also configured to warn a user about websites that aren't safe. Specifically, the main website tracks and catalogs scam sites and sites having a reputation for not shipping product, etc. When a website from the catalogued list of less desirable websites is typed into the URL field by the user, the main website informs the user that the website has a less than desirable reputation.

Combination of the present asynchronous credit card authorization system and method and the information auto-fill hosting feature helps to reinforce that the present system and method is customized to use for all Internet purchases. This method described above, unlike PayPal, does NOT require that any merchants do anything to enable the present system and method on their website. Rather, the present exemplary system and method will work everywhere, worldwide, without modification to present systems.

According to yet anther exemplary embodiment, when accessed by a mobile or tablet technology, a user may navigate to the main website (i.e. shop.veribuy.com) once, then save a shortcut to the site as an icon on their “desktop” (looks like all the other app icons, but just navigates to the URL). When the user wants to browse the web, the regular browser is launched. When the user desires to shop online, the user can launch the main website, i.e. by selecting the Veribuy icon.

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of authorization applications, including, but not limited to, security systems, online payment authorization, remote access protocols, etc.

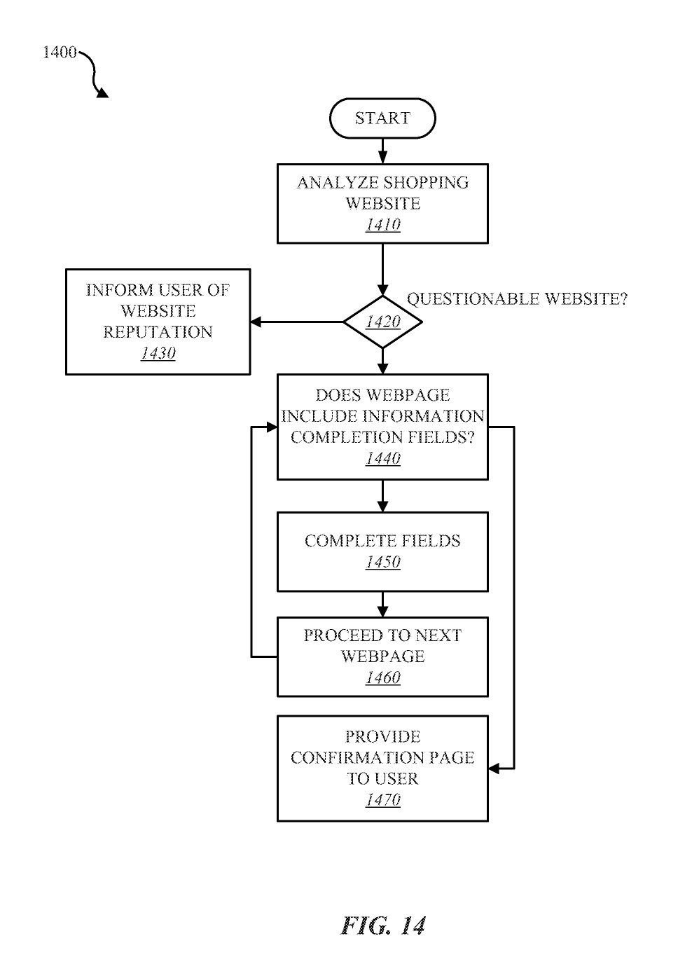

FIG. 14 is a flow diagram illustrating an example of a method 1400 for automatically filling-in data entry fields. In one configuration, the method 1400 may be implemented by the device 105. In particular, the method 1400 may be implemented by the automatic fill-in module 120 executing on the device 105.

At block 1410, a shopping website may be analyzed. At block 1420, a determination may be made as to whether the website is a questionable website. For example, a determination may be made as to what kind of reputation does the website have. In some cases, at block 1430, a user may be informed of the website reputation.

In some cases, the website may be analyzed to determine if it includes any completion fields (e.g., data entry fields). For example, each webpage of a website may be analyzed to determine if it includes any completion fields. At block 1440, a determination may be made as to whether a webpage includes information completion fields. At block 1450, the fields of the webpage may be completed (e.g., filled-in). At block 1460, the above noted process may repeat for each webpage in a website. For example, a determination may be made as to whether the website includes another webpage. If the website includes another webpage, then the method 1400 returns to block 1440 and a determination is made as to whether the webpage includes information completion fields. Upon determining that the webpage includes information completion fields, at block 1450, the fields may be completed. Thus, the method 1400 may automatically fill-in each of the completion fields on each of the webpages of a website. At block 1470, a confirmation page may be provided to the user.

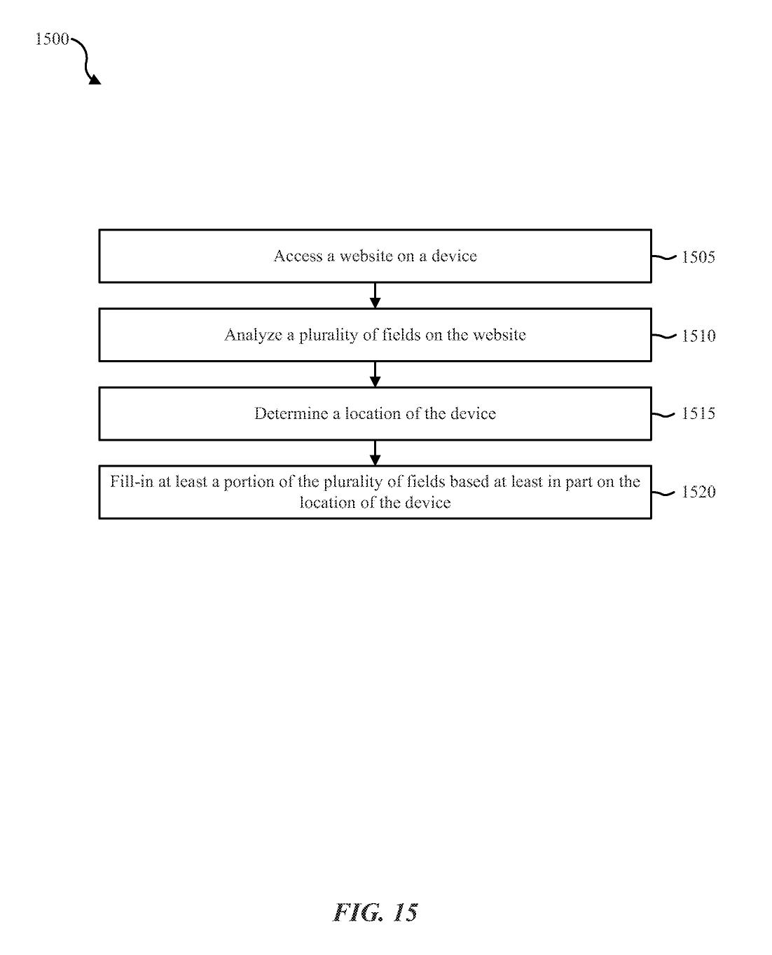

FIG. 15 is a flow diagram illustrating an example of a method 1500 for automatically filling-in data entry fields. In one configuration, the method 1500 may be implemented by the device 105. In particular, the method 1500 may be implemented by the automatic fill-in module 120 executing on the device 105.

At block 1505, a website may be accessed on a device. For example, an application and/or browser may download information corresponding to a cloud based service. At block 1510, a plurality of fields on the website may be analyzed. For example, the each of the plurality of data entry fields on the website may be identified, categorized, and organized. At block 1515, a location of the device may be determined. For example, the location of the device may be determined using one or more positioning systems (e.g., GPS). In some cases, the location of the device may be determined based on a determined situation of the website. At block 1520, at least a portion of the plurality of fields may be filled-in based at least in part on the location of the device. For example, the delivery address may be filled-in based on the location of the device.

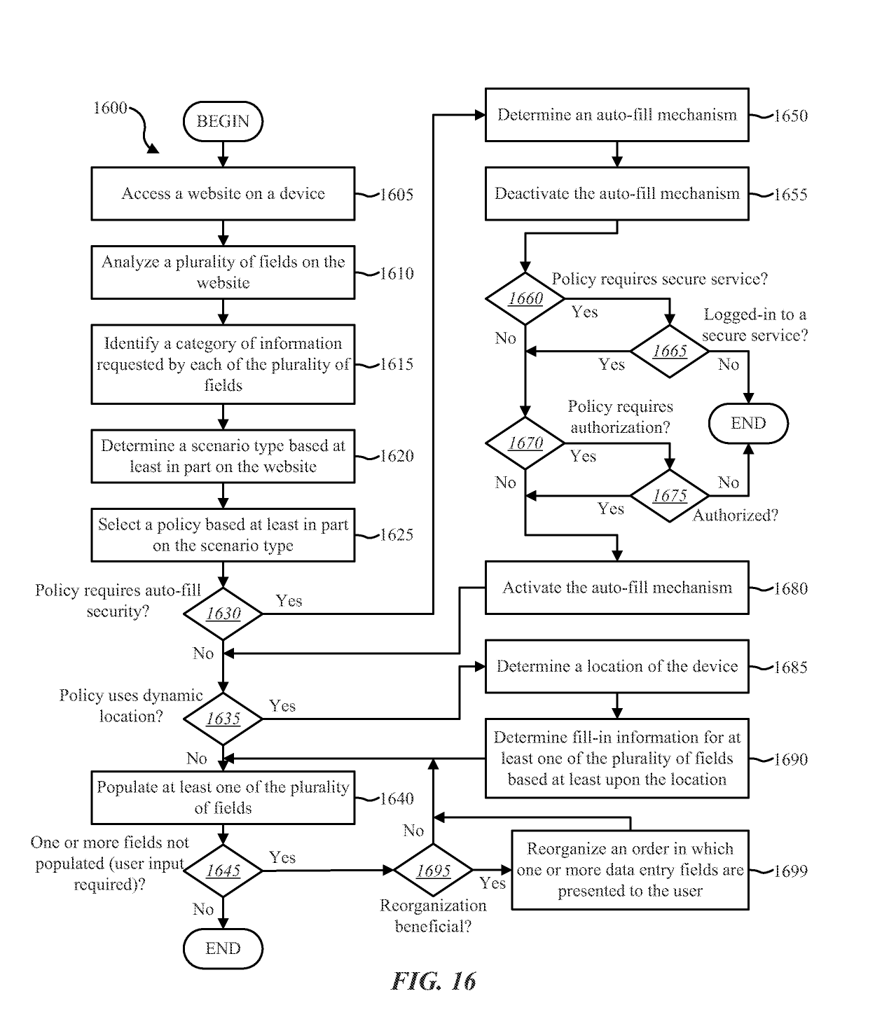

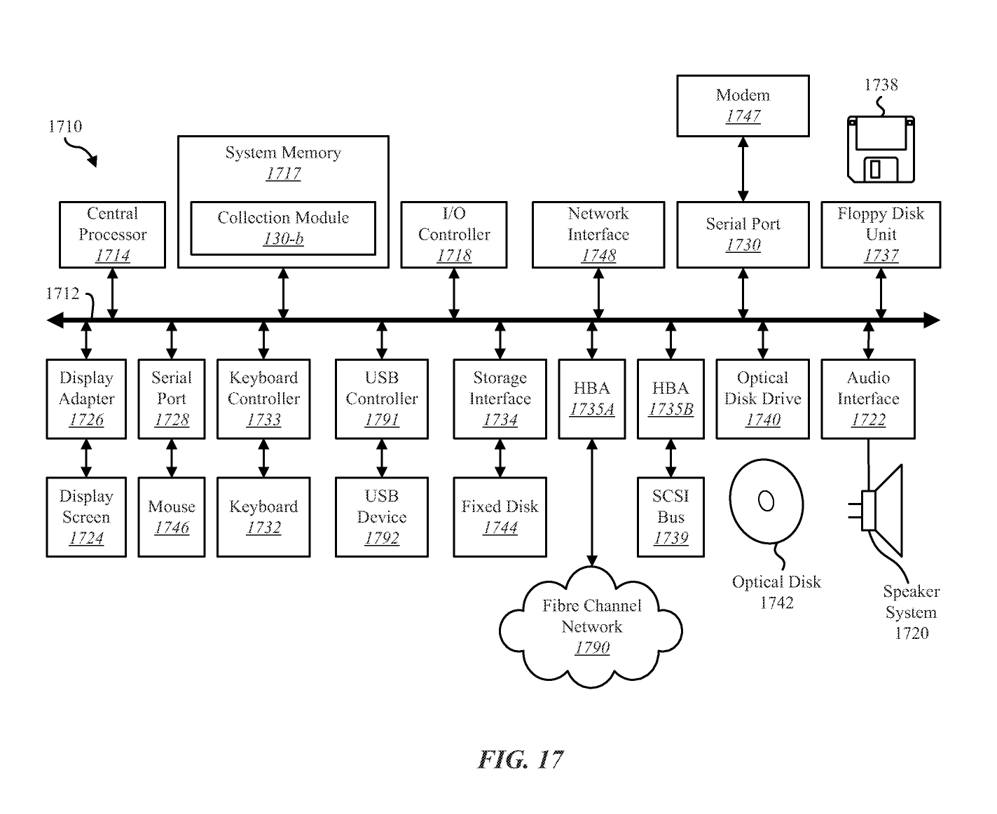

FIG. 16 is a flow diagram illustrating an example of a method 1600 for automatically filling-in data entry fields. In one configuration, the method 1600 may be implemented by the device 105. In particular, the method 1600 may be implemented by the automatic fill-in module 120 executing on the device 105.

At block 1605, a website may be accessed on a device. At block 1610, a plurality of fields on the website may be analyzed. At block 1615, a category of information requested by each of the plurality of fields may be identified. At block 1620, a scenario type may be determined based at least in part on the website. For example, if the website is a short turnaround delivery (e.g., delivery food, flowers, etc.) then the situation may be one in which the location of the device may be used and if the website is a longer turnaround delivery (as in the case of ordering goods from an online retailer, for example) then the situation may be one in which an established address (e.g., home or work address) may be used.

At block 1625, a policy may be selected based at least in part on the scenario type. For example, the policy may utilize the location determination module to determine the location of the delivery address in situations involving quick delivery goods (e.g., delivery food, flowers, etc.) and may use a predetermined established address in situations involving the delivery of household or longer delivery goods. In some cases, the policy may additionally or alternatively require that one or more security features be instituted for utilizing one or more automatic fill-in capabilities.

At block 1630, a determination may be made as to whether the policy requires auto-fill security. If it is determined that the policy does require auto-fill security, then the method 1600 proceeds to block 1650. However, if it is determined that the policy doesn't require auto-fill security, then the method 1600 proceeds to block 1635. Each of these routes may be taken in turn.

At block 1650, an auto-fill mechanism may be determined. For example, it may be determined that the auto-fill mechanism may be a cookie. In another example, the auto-fill mechanism may be determined to be a web browser or web browser plug-in. It is understood that any mechanism that may provide auto-fill-in functionalities may be an auto-fill mechanism. At block 1655, the auto-fill mechanism may be deactivated. For example, the auto-fill mechanism may be disabled so that any automatic fill-in may be prohibited from being performed.

At block 1660, a determination may be made as to whether the policy requires a secure service. For example, a secure service may be being hosted by one or more specified websites and/or browser or browser plug-ins. If it is determined that the policy requires a secure service, then the method 1600 proceeds to block 1665. At block 1665, a determination is made as to whether the user is logged into a secure service. If the user is not logged into a secure service, then the method 1600 ends. It may be noted that the method 1600 ends with any auto-fill mechanism in a deactivated state. If the user is logged into a secure service, then the method 1600 continues to block 1670. At block 1670, a determination may be made as to whether the policy requires authorization. For example, authorization by one or more ACH (via the ATA, for example). If it is determined that the policy does not require authorization, then the method 1600 proceeds to block 1680. If it is determined that the method 1600 does require authorization, then the method 1600 proceeds to block 1675. At block 1675, a determination may be made as to whether the transaction is authorized. If it is determined that the transaction is not authorized, then the method 1600 ends. If it is determined that the transaction is authorized, then the method 1600 proceeds to block 1680. At block 1680, the auto-fill mechanism may be activated. For example, the auto-fill mechanism may be enabled to automatically fill-in one or more data entry fields. The method 1600 proceeds from block 1680 to block 1635.

At block 1635, a determination may be made as to whether the policy uses a dynamic location. If it is determined that the policy does not use a dynamic location, then the method 1600 proceeds to block 1640. If it is determined that the policy does use a dynamic location, then method proceeds to block 1685. At block 1685, a location of the device may be determined. At block 1690, fill-in information for at least one of the plurality of fields may be determined based at least upon the determined location. The method 1600 proceeds from block 1690 to block 1640. At block 1640, the at least one of the plurality of fields may be populated (e.g., filled-in). For example, in some cases, any information that may be automatically determined may automatically filled-in.

At block 1645, a determination may be made as to whether additional user input is required. For example, if one or more of the data entry fields were not able to be automatically filled-in. If it is determined that user input is still required, then the method 1600 proceeds to block 1695. At block 1695 a determination may be made as to whether a reorganization of order in which one or more data entry fields are presented to a user may be beneficial. For instance, if the zip code for an address should be reorganized to be asked sooner (to help fill in city and state information, for example). If it is determined that reorganization of one or more data entry fields would not be beneficial, then the method 1600 proceeds to block 1640. If it is determined that reorganization of one or more data entry fields would be beneficial, then the method 1600 proceeds to block 1699. At block 1699, an order in which one or more data entry fields are presented to the user may be reorganized. The method 1600 proceeds from block 1699 to block 1640. If it is determined that no more user input is required (each of the data entry fields is populated, for example), then the method 1600 ends. In some cases, the method 1600 may deactivate the auto-fill mechanism upon ending.

Therefore, the method 1600 may provide for ways to automatically fill-in one or more data entry fields. It should be noted that the method 1600 is just one implementation and that the operations of the method 1600 may be rearranged or otherwise modified such that other implementations are possible.

FIG. 18 depicts a block diagram of a computer system 1810 suitable for implementing the present systems and methods. Computer system 1810 includes a bus 1812 which interconnects major subsystems of computer system 1810, such as a central processor 1814, a system memory 1817 (typically RAM, but which may also include ROM, flash RAM, or the like), an input/output controller 1818, an external audio device, such as a speaker system 1820 via an audio output interface 1822, an external device, such as a display screen 1824 via display adapter 1826, serial ports 1828 and 1830, a keyboard 1832 (interfaced with a keyboard controller 1833), multiple USB devices 1892 (interfaced with a USB controller 1891), a storage interface 1834, a floppy disk unit 1837 operative to receive a floppy disk 1838, a host bus adapter (HBA) interface card 1835A operative to connect with a Fibre Channel network 1890, a host bus adapter (HBA) interface card 1835B operative to connect to a SCSI bus 1839, and an optical disk drive 1840 operative to receive an optical disk 1842. Also included are a mouse 1846 (or other point-and-click device, coupled to bus 1812 via serial port 1828), a modem 1847 (coupled to bus 1812 via serial port 1830), and a network interface 1848 (coupled directly to bus 1812).

Bus 1812 allows data communication between central processor 1814 and system memory 1817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an automatic fill-in module 120-b to implement the present systems and methods may be stored within the system memory 1817. The automatic fill-in module 120-b may be an example of the automatic fill-in module 120 of FIGS. 1 and/or 2. Applications resident with computer system 1810 are generally stored on and accessed via a non-transitory computer readable medium, such as a hard disk drive (e.g., fixed disk 1844), an optical drive (e.g., optical drive 1840), a floppy disk unit 1837, or other storage medium. Additionally, applications can be in the form of electronic signals modulated in accordance with the application and data communication technology when accessed via network modem 1847 or interface 1848.

Storage interface 1834, as with the other storage interfaces of computer system 1810, can connect to a standard computer readable medium for storage and/or retrieval of information, such as a fixed disk drive 1844. Fixed disk drive 1844 may be a part of computer system 1810 or may be separate and accessed through other interface systems. Modem 1847 may provide a direct connection to a remote server via a telephone link or to the Internet via an internet service provider (ISP). Network interface 1848 may provide a direct connection to a remote server via a direct network link to the Internet via a POP (point of presence). Network interface 1848 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 18 need not be present to practice the present systems and methods. The devices and subsystems can be interconnected in different ways from that shown in FIG. 18. The operation of a computer system such as that shown in FIG. 18 is readily known in the art and is not discussed in detail in this application. Code to implement the present disclosure can be stored in a non-transitory computer-readable medium such as one or more of system memory 1817, fixed disk 1844, optical disk 1842, or floppy disk 1838. The operating system provided on computer system 1810 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for auto-filling information, comprising:
accessing a website on a device;
analyzing a plurality of fields on the website;
determining a location of the device; and
filling-in at least one of the plurality of fields with user information, wherein at least a portion of the user information is based on the location of the device.

2. The method of claim 1, wherein the plurality of fields correspond to an online checkout.

3. The method of claim 2, further comprising:
performing an automated checkout using the at least one filled-in field.

4. The method of claim 1, wherein the user information comprises at least one of credit card information, billing address, delivery address, and pickup address.

5. The method of claim 1, wherein the analyzing the plurality of fields comprises:
identifying each of the plurality of fields;
determining a type of information for each of the identified plurality of fields; and
determining a category of information for each of the identified plurality of fields.

6. The method of claim 5, further comprising:
matching the user information to each of the plurality of fields based on the determined category of each of the plurality of fields.

7. The method of claim 5, further comprising:
matching the user information to each of the plurality of fields based on the determined type of each of the plurality of fields.

8. The method of claim 5, wherein the determined type of information comprises at least one of credit card information, billing address, delivery address, and pickup address.

9. The method of claim 1, wherein at least a portion of the user information is stored in a database.

10. A computing device configured to auto-fill information, comprising:
a processor;
memory in electronic communication with the processor;
instructions stored in the memory, the instructions being executable by a processor to:
access a website on a device;
analyze a plurality of fields on the website;
determine a location of the device; and
fill-in at least one of the plurality of fields with user information, wherein at least a portion of the user information is based on the location of the device.

11. The computing device of claim 10, wherein the plurality of fields correspond to an online checkout.

12. The computing device of claim 11, wherein the instructions are further executable by the processor to:
perform an automated checkout using the at least one filled-in field.

13. The computing device of claim 10, wherein the user information comprises at least one of credit card information, billing address, delivery address, and pickup address.

14. The computing device of claim 10, wherein the instructions executable by the processor to analyze the plurality of fields comprise instructions executable by the processor to:
identify each of the plurality of fields;
determine a type of information for each of the identified plurality of fields; and
determine a category of information for each of the identified plurality of fields.

15. The computing device of claim 14, wherein the instructions are further executable by the processor to:
match the user information to each of the plurality of fields based on the determined category of each of the plurality of fields.

16. The computing device of claim 14, wherein the instructions are further executable by the processor to:
match the user information to each of the plurality of fields based on the determined type of each of the plurality of fields.

17. The computing device of claim 14, wherein the determined type of information comprises at least one of credit card information, billing address, delivery address, and pickup address.

18. The computing device of claim 10, wherein at least a portion of the user information is stored in a database.

19. A computer-program product for auto-filling information, the computer-program product comprising a non-transitory computer-readable medium having instructions thereon, the instructions being executable by a processor to:
access a website on a device;
analyze a plurality of fields on the website;
determine a location of the device; and
fill-in at least one of the plurality of fields with user information, wherein at least a portion of the user information is based on the location of the device.

20. The computer-program product of claim 19, wherein the plurality of fields correspond to an online checkout.

21. A computer-implemented method for securing auto-fill information, comprising:
detecting an auto-fill mechanism;
disabling the auto-fill mechanism;
detecting a security condition;
determine that the security condition has been satisfied; and
upon determining that the security position has been satisfied, enabling the auto-fill mechanism.

22. The method of claim 21 wherein the security condition comprises a logged in state with a secure service.

23. The method of claim 21, wherein the security condition comprises obtaining a transaction authorization.

24. The method of claim 23, wherein the transaction authorization is obtained using an asynchronous transaction authorization system.

25. A computer-implemented method for reorganizing a plurality of fields, comprising:
identifying a plurality of fields;
determining an order of the plurality of fields, wherein a first field is ordered before a second field;
determining a category of information for each of the plurality of fields, wherein the first field has a first category of information and the second field has a second category of information;
determining that the second category of information provides information about the first category of information; and
reordering at least the first field and the second field so that the second field is ordered before the first field.
